(19) United States
(12) Patent Application Publication
(10) Pub. No.: US 2023/0344304 A1
(43) Pub. Date: Oct. 26, 2023

(54) POWER TRANSMISSION DEVICE

(71) Applicant: DENSO CORPORATION, Kariya-city (JP)

(72) Inventors: Takafumi MATSUMOTO, Kariya-city (JP); Hiroto INOUE, Kariya-city (JP); Takuro SAHARA, Kariya-city (JP); Shinji HASHIMOTO, Kariya-city (JP); Ryu FUKUSHIMA, Kariya-city (JP); Ryotaro SUZUKI, Kariya-city (JP); Riku OUCHI, Kariya-city (JP); Shinji KAWADA, Kariya-city (JP); Toshihisa NAKAJIMA, Kariya-city (JP); Seiichiro WASHINO, Kariya-city (JP)

(21) Appl. No.: 18/333,399

(22) Filed: Jun. 12, 2023

Related U.S. Application Data
(63) Continuation of application No. PCT/JP21/42163, filed on Nov. 17, 2021.

(30) Foreign Application Priority Data
Dec. 15, 2020 (JP) 2020-207606
Feb. 5, 2021 (JP) 2021-017410
Apr. 20, 2021 (JP) 2021-071315
Oct. 11, 2021 (JP) 2021-166901

(51) Int. Cl. H02K 7/10; H02K 49/00; F04D 25/02; B60H 1/32

(52) U.S. Cl. CPC H02K 7/10; H02K 49/00; F04D 25/026; B60H 1/3204; B60H 2001/3286

(57) ABSTRACT

A power transmission device includes: a pole piece configured to rotate by modulating a magnetic flux between a drive-side magnet and a stationary magnet; and a sealing member that partitions an inside of a housing into a driving side space where the drive-side magnet is disposed and a driven side space where the stationary magnet and the pole piece are disposed, so as to seal fluid between the driving side space and the driven side space. The pole piece and the stationary magnet have a cylindrical shape and are disposed coaxially with and radially outer side of the drive-side magnet. The sealing member includes: a sealing cylinder portion positioned radially outer side of the drive-side magnet; and a sealing bottom surface portion covering the sealing cylinder portion from the driving side space.

### CROSS REFERENCE TO RELATED APPLICATION

The present application is a continuation application of International Patent Application No. PCT/JP2021/042163 filed on Nov. 17, 2021, which designated the U.S. and claims the benefit of priority from Japanese Patent Application No. 2020-207606 filed on Dec. 15, 2020, Japanese Patent Application No. 2021-17410 filed on Feb. 5, 2021, Japanese Patent Application No. 2021-71315 filed on Apr. 20, 2021, and Japanese Patent Application No. 2021-166901 filed on Oct. 11, 2021. The entire disclosures of all of the above applications are incorporated herein by reference.

### TECHNICAL FIELD

The present disclosure relates to a power transmission device that transmits power using magnetic force.

### BACKGROUND ART

A power transmission device has a first movable member, a second movable member, a magnet, and an intermediate yoke disposed between the first movable member and the second movable member. Rotation of the second movable member rotates the first movable member by magnetic interaction.

### SUMMARY

According to an aspect of the present disclosure, a power transmission device includes a drive-side magnet, a housing, a stationary magnet, a pole piece, and a sealing member. The drive-side magnet includes a plurality of poles and rotates. The housing houses the drive-side magnet. The stationary magnet has a number of poles larger than a number of poles of the drive-side magnet and is fixed to the housing. The pole piece includes a plurality of magnetic body portions and rotates by modulating a magnetic flux between the drive-side magnet and the stationary magnet. The sealing member partitions an inside of the housing into a driving side space where the drive-side magnet is disposed and a driven side space where the stationary magnet and the pole piece are disposed, and seals fluid between the driving side space and the driven side space. The pole piece and the stationary magnet have a cylindrical shape and are disposed coaxially with and radially outer side of the drive-side magnet. The sealing member includes a sealing cylinder portion positioned radially outer side of the drive-side magnet and a sealing bottom surface portion covering the sealing cylinder portion from the driving side space.

### BRIEF DESCRIPTION OF THE DRAWINGS

FIG. 1 is an overall configuration diagram illustrating a vapor compression refrigeration cycle of a first embodiment.

FIG. 2 is a cross-sectional view illustrating a first expansion valve of the first embodiment.

FIG. 3 is a cross-sectional view of III-Ill of FIG. 2.

FIG. 4 is a cross-sectional view illustrating a first expansion valve of a second embodiment.

FIG. 5 is a cross-sectional view of V-V of FIG. 4.

FIG. 6 is a cross-sectional view illustrating a first expansion valve of a third embodiment.

FIG. 7 is a cross-sectional view of VII-VII of FIG. 6.

FIG. 8 is a cross-sectional view illustrating a first expansion valve of a fourth embodiment.

FIG. 9 is a cross-sectional view illustrating a first expansion valve of a fifth embodiment.

FIG. 10 is a block diagram illustrating a control system of a first expansion valve of a sixth embodiment.

FIG. 11 is a graph illustrating a result of frequency analysis on input current in the sixth embodiment.

FIG. 12 is a flowchart regarding lock determination control in the sixth embodiment.

FIG. 13 is a block diagram illustrating a control system of a first expansion valve of a seventh embodiment.

FIG. 14 is a graph illustrating a result of frequency analysis on an envelope of drive current in the seventh embodiment.

FIG. 15 is a block diagram illustrating a control system oft a first expansion valve of an eighth embodiment.

FIG. 16 is a graph illustrating a result of frequency analysis on drive current in the eighth embodiment.

FIG. 17 is a block diagram illustrating a control system of a first expansion valve of a ninth embodiment.

FIG. 18 is a graph illustrating a result of frequency analysis on determination voltage in the ninth embodiment.

FIG. 19 is a block diagram illustrating a control system of a first expansion valve of a tenth embodiment.

FIG. 20 is a graph illustrating a result of frequency analysis on drive current in the tenth embodiment.

FIG. 21 is a block diagram illustrating a control system of a first expansion valve of an eleventh embodiment.

FIG. 22 is a graph illustrating a result of frequency analysis on a line voltage in the eleventh embodiment.

FIG. 23 is a cross-sectional view illustrating a configuration of a first expansion valve of a twelfth embodiment.

FIG. 24 is a graph illustrating a result of frequency analysis on acceleration in the twelfth embodiment.

FIG. 25 is a cross-sectional view of a motor unit and a drive-side magnet in a first expansion valve of a thirteenth embodiment.

FIG. 26 is a circuit diagram illustrating a part of an electric circuit of the motor unit of the thirteenth embodiment.

FIG. 27 is a graph illustrating a relationship between a rotation angle in one phase of the motor unit and induced voltages by the drive-side magnet of the thirteenth embodiment.

FIG. 28 is a cross-sectional view of a motor unit and a drive-side magnet in a first expansion valve of a fourteenth embodiment.

FIG. 29 is a circuit diagram illustrating a part of an electric circuit of the motor unit of the fourteenth embodiment.

FIG. 30 is a graph illustrating a relationship between a rotation angle in one phase of the motor unit and induced voltages by the drive-side magnet of the fourteenth embodiment.

FIG. 31 is a cross-sectional view of a motor unit and a drive-side magnet in a first expansion valve of a fifteenth embodiment.

FIG. 32 is a circuit diagram illustrating a part of an electric circuit of the motor unit of the fifteenth embodiment.

FIG. 33 is a cross-sectional view of a motor unit and a drive-side magnet in a first expansion valve of a sixteenth embodiment.

FIG. 34 is an explanatory view illustrating a part of a configuration of a first expansion valve in a seventeenth embodiment.

FIG. 35 is a cross-sectional view illustrating a part of a first expansion valve of an eighteenth embodiment.

FIG. 36 is an arrow view of XXXVI of FIG. 35.

FIG. 37 is a plan view illustrating a reinforcing plate and a circuit unit of a nineteenth embodiment.

FIG. 38 is a cross-sectional view illustrating a part of a first expansion valve of a twentieth embodiment.

FIG. 39 is a plan view illustrating a reinforcing plate of the twentieth embodiment.

FIG. 40 is a plan view illustrating a substrate of the twentieth embodiment.

FIG. 41 is a cross-sectional view illustrating a soldering portion of the substrate and a FET microcomputer of the twentieth embodiment.

FIG. 42 is a cross-sectional view describing a deformation state of the substrate in the twentieth embodiment.

FIG. 43 is a plan view illustrating a reinforcing plate of a twenty-first embodiment.

FIG. 44 is a plan view illustrating a substrate of the twenty-first embodiment.

FIG. 45 is a flowchart depicting a modification of the lock determination control.

FIG. 46 is a cross-sectional view illustrating a flow regulation valve to which the power transmission device is applied.

FIG. 47 is a cross-sectional view illustrating a compact pump to which the power transmission device is applied.

FIG. 48 is a cross-sectional view illustrating a first expansion valve of a twenty-second embodiment.

FIG. 49 is a cross-sectional view illustrating a flow of magnetic flux in the first expansion valve of the twenty-second embodiment.

### DESCRIPTION OF EMBODIMENTS

Conventionally, a power transmission device is known, in which magnets are disposed in a first movable member and a second movable member, and an intermediate yoke is disposed between the first movable member and the second movable member. Magnetic bodies are disposed in the intermediate yoke.

All of the first movable member, the intermediate yoke, and the second movable member have a cylindrical shape and are disposed coaxially with one another. Rotation of the second movable member rotates the first movable member by magnetic interaction. At this time, the pole number ratio between the first movable member and the second movable member becomes a gear ratio.

The intermediate yoke is fitted to a cylindrical partition wall that separates a space on the first movable member side from a space on the second movable member side.

There is a need for an increase in torque for the prior art. As a method in response to the need, it is considered that the number of poles of the magnet is changed to increase a reduction gear ratio. However, a change in the number of poles of the magnet results in a complicated structure and an increase in cost.

In the prior art, since the intermediate yoke is fitted to the partition wall, it is difficult to increase pressure resistance of the partition wall.

Especially, when the power transmission device is applied to an expansion valve used for a refrigeration cycle of a vehicle air conditioner, since significant downsizing is required due to convenience of mounting space, it is difficult to ensure the pressure resistance against high pressure refrigerant. Due to convenience of the mounting space, there may be a case where arrangement in which refrigerant enters the power transmission device and becomes resistance of rotation, such as transverse placement and inverse placement, is performed, and therefore a need for increase in torque has been increasing.

In consideration of the points, an object of this disclosure is to increase pressure resistance in addition to an increase in a reduction gear ratio without changing a number of poles of a magnet.

According to an aspect of the present disclosure, a power transmission device includes a drive-side magnet, a housing, a stationary magnet, a pole piece, and a sealing member.

The drive-side magnet includes a plurality of poles and rotates. The housing houses the drive-side magnet. The stationary magnet has a number of poles larger than a number of poles of the drive-side magnet and is fixed to the housing.

The pole piece includes a plurality of magnetic body portions, and modulates a magnetic flux between the drive-side magnet and the stationary magnet to rotate.

The sealing member partitions an inside of the housing into a driving side space where the drive-side magnet is disposed and a driven side space where the stationary magnet and the pole piece are disposed, and seals fluid between the driving side space and the driven side space.

The pole piece and the stationary magnet have a cylindrical shape and are disposed coaxially with and radially outer side of the drive-side magnet. The sealing member includes a sealing cylinder portion positioned radially outer side of the drive-side magnet and a sealing bottom surface portion covering the sealing cylinder portion from the driving side space.

According to this, since the stationary magnet is fixed to the housing and the pole piece is rotated, compared with a configuration of fixing the pole piece to the housing, the reduction gear ratio can be increased. This is because the number of poles of the pole piece is larger than the number of poles of the stationary magnet.

Since the sealing member can be the member independent of the pole piece, the pressure resistance of the sealing member can be increased.

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

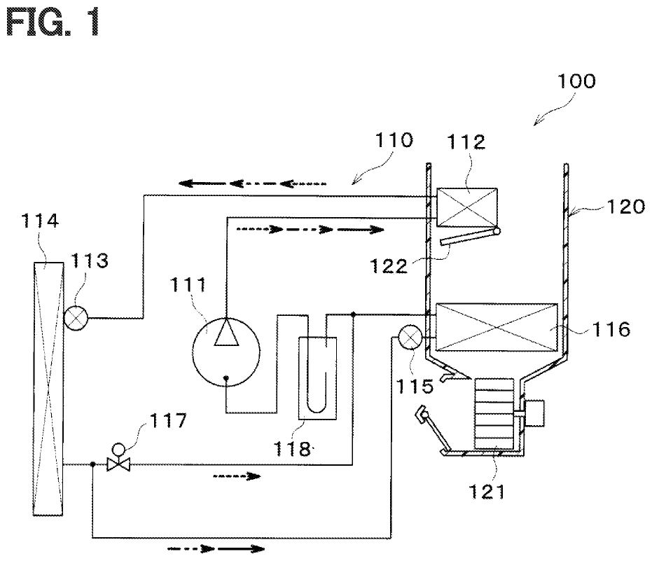

The first embodiment in this disclosure will be described with reference to FIG. 1 to FIG. 3. A power transmission device 1 of this embodiment is applied to a first expansion valve 113 and a second expansion valve 115 of a vapor compression refrigeration cycle 110. The vapor compression refrigeration cycle 110 is applied to a vehicle air conditioner 100 illustrated in FIG. 1. The vehicle air conditioner 100 is applied to an electric vehicle that obtains driving power for vehicle traveling from an electric motor for traveling.

The vehicle air conditioner 100 has three operation modes, an air cooling mode for air-conditioning a vehicle interior, a heating mode for heating the vehicle interior, and a dehumidification heating mode for heating while dehumidifying the vehicle interior. FIG. 1 illustrates a flow of refrigerant in the air cooling mode by the solid arrow, illustrates a flow of the refrigerant in the heating mode by the dashed arrow, and illustrates a flow of the refrigerant in the dehumidification heating mode by the two-dot chain line arrow.

The vehicle air conditioner 100 includes the vapor compression refrigeration cycle 110 and a vehicle interior air conditioning unit 120.

The vapor compression refrigeration cycle 110 includes a compressor 111, an interior heat exchanger 112, the first expansion valve 113, an exterior heat exchanger 114, the second expansion valve 115, an evaporator 116, an electromagnetic open/close valve 117, and an accumulator 118.

The compressor 111 is an electric compressor that suctions, compresses, and discharges the refrigerant. As the refrigerant circulating in the vapor compression refrigeration cycle, fluorocarbon refrigerant (such as R134a) is employed. The vapor compression refrigeration cycle is a subcritical cycle in which high pressure side refrigerant pressure does not exceed critical pressure of the refrigerant.

The interior heat exchanger 112 heat-exchanges the refrigerant discharged from the compressor 111 for air flowed in the vehicle interior air conditioning unit 120 and condenses the refrigerant. The first expansion valve 113 decompresses and expands the refrigerant condensed by the interior heat exchanger 112. The exterior heat exchanger 114 heat-exchanges the refrigerant flowed out from the first expansion valve 113 for external air. The second expansion valve 115 decompresses and expands the refrigerant flowed out from the exterior heat exchanger 114. The evaporator 116 heat-exchanges the refrigerant decompressed and expanded by the second expansion valve 115 for the air flowing inside the vehicle interior air conditioning unit 120 and vaporizes the refrigerant. The electromagnetic open/close valve 117 is a solenoid valve that opens and closes a refrigerant flow passage to bypass the refrigerant flowed out from the exterior heat exchanger 114 to the second expansion valve 115 and the evaporator 116 and guide the refrigerant to the accumulator 118. The accumulator 118 separates the refrigerant vaporized in the evaporator 116 and the refrigerant that has passed through the electromagnetic open/close valve 117 into gas and liquid.

The vehicle interior air conditioning unit 120 is disposed in the vehicle interior and internally forms an air passage. A blower 121, the evaporator 116, the exterior heat exchanger 114, and an air mix door 122 are disposed in the air passage inside the vehicle interior air conditioning unit 120. The blower 121 is an electric blower that sends air to the air passage inside the vehicle interior air conditioning unit 120. The evaporator 116 is disposed downstream of airflow with respect to the blower 121. The interior heat exchanger 112 is disposed downstream of airflow with respect to the evaporator 116. The air mix door 122 adjusts a flow ratio between the air flowing to the interior heat exchanger 112 and the air flowing by bypassing the interior heat exchanger 112. The vehicle interior air conditioning unit 120 blows out the air whose temperature has been adjusted by the air mix door 122 to the vehicle interior.

In the air cooling mode of the vehicle air conditioner 100, the electromagnetic open/close valve 117 is in a valve-closed state, and the air mix door 122 obstructs the air flow passage to the interior heat exchanger 112. Therefore, the refrigerant discharged from the compressor 111 is not heat-exchanged in the interior heat exchanger 112 but passes through the interior heat exchanger 112, flows in the order of the first expansion valve 113, the exterior heat exchanger 114, the second expansion valve 115, the evaporator 116, and the accumulator 118, and returns to the compressor 111 from the accumulator 118.

At this time, the first expansion valve 113 is set to a valve opening degree at which the flow of the refrigerant is not reduced, and the second expansion valve 115 is set to a valve opening degree at which the flow of the refrigerant is reduced, and therefore the refrigerant is condensed in the exterior heat exchanger 114 and the refrigerant is vaporized in the evaporator 116.

In the heating mode of the vehicle air conditioner 100, the electromagnetic open/close valve 117 is in the valve-opening state, the second expansion valve 115 is in the valve-closed state of shutting off the flow of the refrigerant, and the air mix door 122 is opened such that the air flows to the interior heat exchanger 112. Therefore, the refrigerant discharged from the compressor 111 flows in the order of the interior heat exchanger 112, the first expansion valve 113, the exterior heat exchanger 114, the electromagnetic open/close valve 117, and the accumulator 118, and returns to the compressor 111 from the accumulator 118. At this time, the first expansion valve 113 is set to a valve opening degree at which the flow of the refrigerant is reduced, and the second expansion valve 115 is set to the valve-closed state, and therefore the refrigerant is condensed in the interior heat exchanger 112, the refrigerant is vaporized in the exterior heat exchanger 114, and the refrigerant does not flow to the evaporator 116.

In the dehumidification heating mode of the vehicle air conditioner 100, the electromagnetic open/close valve 117 is in the valve-closed state, and the air mix door 122 is opened such that the air flows to the interior heat exchanger 112. Therefore, the refrigerant discharged from the compressor 111 flows in the order of the interior heat exchanger 112, the first expansion valve 113, the exterior heat exchanger 114, the second expansion valve 115, the evaporator 116, and the accumulator 118, and returns to the compressor 111 from the accumulator 118.

At this time, since the first expansion valve 113 and the second expansion valve 115 are set to the valve opening degrees at which the flow of the refrigerant is reduced, the refrigerant is condensed in the interior heat exchanger 112 and the refrigerant is vaporized in the exterior heat exchanger 114.

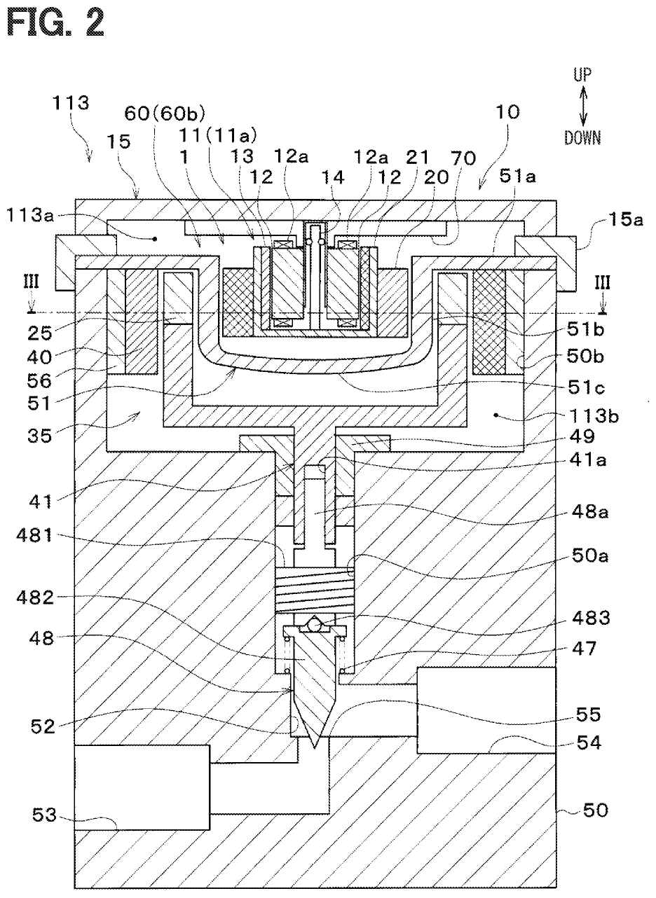

As illustrated in FIG. 2, the first expansion valve 113 includes the power transmission device 1, a driving side mechanism unit 10, and a driven side mechanism unit 35. The first expansion valve 113 is vertically disposed in a vehicle. The vertical arrangement is arrangement in which an axial direction of a valve element 48 becomes approximately parallel to a vehicle vertical direction and the driving side mechanism unit 10 is on the upper side of the vehicle with respect to the driven side mechanism unit 35.

The power transmission device 1 transmits driving power generated by the driving side mechanism unit 10 to the driven side mechanism unit 35 using magnetic force.

The driving side mechanism unit 10 includes a motor unit 11 and a motor case 15. The motor unit 11 is three-phase motors 11a and includes a stator 12, a rotor 13, and a shaft 14. The shaft 14 is an input shaft of the power transmission device 1 and integrally rotates with the rotor 13. The motor case 15 houses the motor unit 11.

The stator 12 is fixed to the motor case 15. The stator 12 includes stator coils 12a. In this example, the number of slots Ns of the stator 12 is 6.

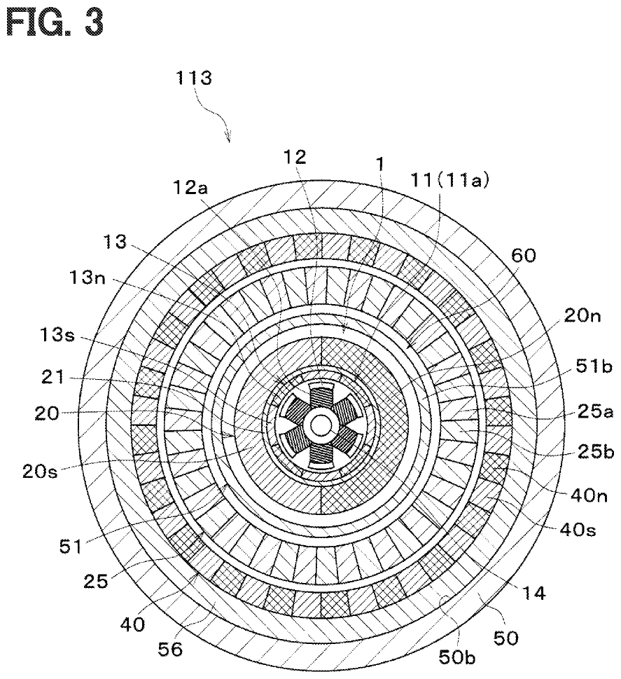

The rotor 13 has a cylindrical shape and the stator 12 is disposed inside the rotor 13. As illustrated in FIG. 3, in the rotor 13, a plurality of sets of a pair of magnets formed of a N-pole 13n and a S-pole 13s are disposed along a circumferential direction. In this example, since four pieces of each of the N-poles 13n and the S-poles 13s are provided, the number of poles Pr of the rotor 13 is 8. The stator 12 and the rotor 13 output driving power to rotate the shaft 14 by electromagnetic force.

In the motor case 15, an axis alignment portion 15a that aligns (centers) the shaft 14 of the driving side mechanism unit 10 with a rotating member 41 of the driven side mechanism unit 35 is formed. The axis alignment portion 15a is fitted to a body portion 50 of the driven side mechanism unit 35.

The motor case 15 internally houses a circuit portion 70. The circuit portion 70 includes a circuit board that includes a plurality of electronic components for controlling the three-phase motors 11a as the motor unit 11.

The driven side mechanism unit 35 includes the rotating member 41, the valve element 48, a bearing member 49, and the body portion 50.

The body portion 50 houses the rotating member 41, the valve element 48, and the bearing member 49. The body portion 50 constitutes a housing of the first expansion valve 113 together with the motor case 15. In the body portion 50, a valve chamber 52, an inlet side connection port 53, an outlet side connection port 54, and a valve seat 55 are formed.

The rotating member 41 is an output shaft of the power transmission device 1 and rotates by driving power transmitted from the driving side mechanism unit 10. The rotating member 41 is a rod-shaped member and disposed coaxially with the shaft 14. An engaging groove 41a is formed in an end portion on a side opposite to the driving side mechanism unit 10 in the rotating member 41. The rotating member 41 is rotatably supported by the bearing member 49 fixed to the body portion 50.

The valve element 48 is a rod-shaped member disposed inside the valve chamber 52. The valve element 48 is disposed coaxially with the rotating member 41. A projecting piece 48a of the valve element 48 engages with the engaging groove 41a of the rotating member 41. Thus, the rotation force of the rotating member 41 is transmitted to the valve element 48.

The projecting piece 48a is formed on one end of the valve element 48. A male thread is formed on the outer peripheral surface of the valve element 48. The male thread of the valve element 48 is screwed with a screw hole 50a formed in the body portion 50 to constitute a screw mechanism. Thus, when the valve element 48 rotates, the valve element 48 axially moves.

The valve element 48 is formed of a plurality of members. Specifically, the valve element 48 includes a male thread member 481 positioned on the rotating member 41 side and the above-described male thread is formed on the male thread member 481, a valve seat side member 482 positioned on the valve seat 55 side, and a ball 483 disposed between both members 481, 482. By the ball 483 being disposed between both members 481, 482, the valve seat side member 482 in the valve element 48 does not rotate but axially moves.

The valve seat side member 482 forming a ball receiving member in the valve element 48 is biased by a coil spring 47 to a side in which the valve element 48 is axially away from the valve seat 55.

By the valve element 48 axially moving, the valve element 48 abuts on the valve seat 55 and is away from the valve seat 55 to open and close the valve chamber 52. When the valve element 48 is away from the valve seat 55 in the valve chamber 52, the refrigerant flows from the inlet side connection port 53 to the outlet side connection port 54 to be decompressed and expanded.

The power transmission device 1 includes a contactless coupling portion 60. The contactless coupling portion 60 includes a magnetic gear 60b and a sealing plate 51. The magnetic gear 60b includes a drive-side magnet 20, a pole piece 25, and a stationary magnet 40.

The drive-side magnet 20 integrally rotates with the shaft 14 of the motor unit 11. The pole piece 25 modulates magnetic flux between the drive-side magnet 20 and the stationary magnet 40 and integrally rotates with the rotating member 41. The stationary magnet 40 is fixed to the body portion 50 of the first expansion valve 113.

The drive-side magnet 20 has a cylindrical shape and is joined to the outer peripheral surface of the rotor 13 of the motor unit 11 via a cylindrical interposition member 21. That is, the motor unit 11 is disposed inside the drive-side magnet 20. The interposition member 21 is made of a magnetic body.

In the drive-side magnet 20, at least one set of a pair of magnets formed of a N-pole 20n and a S-pole 20s are disposed along the circumferential direction. In this example, since one piece of each of the N-pole 20n and the S-pole 20s are provided, the number of poles Pin of the drive-side magnet 20 is 2.

The number of poles Pin of the drive-side magnet 20 is the same as a value found by subtracting the number of slots Ns of the stator 12 from the number of poles Pr of the rotor 13. In this example, since the number of poles Pr of the rotor 13 is 8 and the number of slots Ns of the stator 12 is 6, the number of poles Pin of the drive-side magnet 20 is 2.

The sealing plate 51 is a sealing member that partitions an internal space of the first expansion valve 113 into a driving side space 113a and a driven side space 113b and seals the driven side space 113b. The driving side space 113a is a space on the driving side mechanism unit 10 side, and the driven side space 113b is a space on the driven side mechanism unit 35 side.

The sealing plate 51 reduces a leakage of the refrigerant present in the driven side space 113b (high pressure refrigerant) to the driving side space 113a. In this example, the sealing plate 51 is made of a non-magnetic body (such as SUS305).

The sealing plate 51 has a disk shape having a center portion depressed downward and includes a sealing top surface portion 51a, a sealing cylinder portion 51b, and a sealing bottom surface portion 51c. The sealing top surface portion 51a has an annular plate shape and an outer edge portion fixed to the body portion 50 of the first expansion valve 113. The sealing cylinder portion 51b has a cylindrical shape and is positioned on the outer diameter side of the drive-side magnet 20. The sealing bottom surface portion 51c is positioned on the lower side of the drive-side magnet 20 and covers the sealing cylinder portion 51b from the driving side space 113a side.

The sealing bottom surface portion 51c has a circular plate shape having the center portion curved downward. The corner portion forming a boundary between the sealing cylinder portion 51b and the sealing bottom surface portion 51c is not a right angle but has a shape rounded at a predetermined curvature radius to enhance pressure resistance.

To improve the pressure resistance of the sealing plate 51, the sealing top surface portion 51a, the sealing cylinder portion 51b, and the sealing bottom surface portion 51c are integrally molded.

The sealing bottom surface portion 51c is disposed in a void between the shaft 14 and the rotating member 41 in the axial direction of the shaft 14 and the rotating member 41. That is, the sealing bottom surface portion 51c is disposed in a position where the number of torque generation points is small. Therefore, torque resistance and the pressure resistance in the sealing plate 51 is easily ensured.

The pole piece 25 has a cylindrical shape and is disposed on the outer diameter side of the sealing cylinder portion 51b of the sealing plate 51. The pole piece 25 is joined to the rotating member 41 of the driven side mechanism unit 35.

The stationary magnet 40 has a cylindrical shape and is disposed on the outer diameter side of the pole piece 25. The stationary magnet 40 is fitted to a cylindrical body cylinder portion 50b (in other words, a housing cylinder portion) in the body portion 50 (in other words, the housing) via a cylindrical back yoke 56. The back yoke 56 and the body cylinder portion 50b are made of magnetic bodies.

In the stationary magnet 40, a plurality of a pair of magnets formed of a N-pole 40n and a S-pole 40s are disposed at approximately regular intervals along the circumferential direction. The number of poles Pf of the stationary magnet 40 is larger than the number of poles Pin of the drive-side magnet 20. In this example, since 20 pieces of each of the N-poles 40n and the S-poles 40s are provided, the number of poles Pf of the stationary magnet 40 is 40.

An axial length L2 of the stationary magnet 40 is longer than an axial length L1 of the drive-side magnet 20. Thus, an area between the pole piece 25 and the stationary magnet 40 where the number of torque generation points is large can be increased.

The pole piece 25 includes a plurality of magnetic body portions 25a and a plurality of non-magnetic body portions 25b. The magnetic body portion 25a and the non-magnetic body portion 25b have a trapezoidal fan shape, and the magnetic body portions 25a are disposed at approximately regular intervals along the circumferential direction. The non-magnetic body portion 25b is disposed between the magnetic body portions 25a. For example, the magnetic body portion 25a is made of a soft magnetic body (such as iron-based metal), and the non-magnetic body portion 25b is made of a non-magnetic body (such as stainless steel or resin).

The number of poles Pp of the pole piece 25 is the same as the total of the number of poles Pin of the drive-side magnet 20 and the number of poles Pf of the stationary magnet 40. In this example, the number of poles Pin of the drive-side magnet 20 is 2 and the number of poles Pf of the stationary magnet 40 is 40, and therefore the number of poles Pp of the pole piece 25 is 42. That is, each of the magnetic body portions 25a and the non-magnetic body portions 25b are 21 pieces. That is, the number of pieces Npp of the magnetic body portions 25a has the following relationship with the number of poles Pin of the drive-side magnet 20 and the number of poles Pf of the stationary magnet 40.

Npp=(Pin+Pf)/2

An axial length Lp of the pole piece 25 is shorter than the axial length L2 of the stationary magnet 40. Accordingly, a magnetic flux leakage in the axial direction at the pole piece 25 can be reduced and transmission torque can be improved.

The configuration of the second expansion valve 115 is similar to the first expansion valve 113.

Next, the actuation of the power transmission device 1 according to this embodiment will be described. When the shaft 14 of the motor unit 11 rotates to integrally rotate with the drive-side magnet 20, due to the magnetic interaction between the drive-side magnet 20 and the stationary magnet 40, the pole piece 25 rotates in a direction same as the rotation direction of the drive-side magnet 20.

A reduction gear ratio at this time is the same as a value found by dividing the number of poles Pp of the pole piece 25 by the number of poles Pin of the drive-side magnet 20. Since the number of poles Pp of the pole piece 25 is larger than the number of poles Pin of the drive-side magnet 20, the rotation speed of the pole piece 25 becomes smaller than the rotation speed of the drive-side magnet 20.

In this example, the number of poles Pp of the pole piece 25 is 42 and the number of poles Pin of the drive-side magnet 20 is 2, and therefore the reduction gear ratio is 21.

In contrast to this, in a configuration in which the pole piece 25 is fixed and a magnet having the number of poles same as that of the stationary magnet 40 is joined to the rotating member 41 of the driven side mechanism unit 35 to rotate (hereinafter, the configuration is referred to as a comparative example), the reduction gear ratio is 20.

Since the number of poles Pp of the pole piece 25 is larger than the number of poles Pf of the stationary magnet 40, in this embodiment in which the pole piece 25 is rotated, the reduction gear ratio is larger than that of the comparative example in which the magnet having the number of poles same as that of the stationary magnet 40 is rotated.

In this embodiment of rotating the pole piece 25, the pole piece 25 is a member independent of the sealing plate 51. Therefore, as in the prior art, compared with the structure in which the pole piece does not rotate and is buried in the sealing plate, the pressure resistance of the sealing plate 51 can be improved.

In this embodiment, the sealing plate 51 includes the sealing cylinder portion 51b and the sealing bottom surface portion 51c. Accordingly, the sealing plate 51 has a disk shape with the center portion depressed toward the driven side mechanism unit 35. Therefore, since the sealing plate 51 can be disposed as a member independent of the pole piece 25, the pressure resistance of the sealing plate 51 can be enhanced.

In this embodiment, the number of pieces Npp of the magnetic body portions 25a that the pole piece 25 has the following relationship with the number of poles Pin of the drive-side magnet 20 and the number of poles Pf of the stationary magnet 40.

Npp=(Pin+Pf)/2

Accordingly, the rotation force of the drive-side magnet 20 can be transmitted to the pole piece 25.

In this embodiment, the stationary magnet 40 is fixed to the inner peripheral surface of the back yoke 56, and the back yoke 56 is fixed to the inner peripheral surface of the body cylinder portion 50b. Thus, the stationary magnet 40 is easily press-fitted to the body portion 50.

In this embodiment, the stator 12 and the rotor 13 are disposed inside the drive-side magnet 20. Therefore, the physical size of the first expansion valve 113 in the axial direction can be downsized.

In this embodiment, the interposition member 21 is disposed between the rotor 13 and the drive-side magnet 20. Accordingly, the rotor 13 can be properly disposed inside the drive-side magnet 20.

In this embodiment, in the axial direction of the drive-side magnet 20, the pole piece 25 is shorter than the drive-side magnet 20 and the stationary magnet 40. Accordingly, a magnetic flux leakage in the axial direction at the pole piece 25 can be reduced and transmission torque can be improved.

In the axial direction of the drive-side magnet 20, the stationary magnet 40 is longer than the drive-side magnet 20. Thus, an area between the pole piece 25 and the stationary magnet 40 where the number of torque generation points is large can be increased.

In this embodiment, in the axial direction of the drive-side magnet 20, the drive-side magnet 20 is longer than the pole piece 25 and shorter than the stationary magnet 40. Thus, since the magnetic flux leakage at the pole piece 25 in the axial direction can be reduced and the area of the surface where the torque occurs can be largely ensured, transmission torque can be improved.

In this embodiment, by the axis alignment portion 15a of the motor case 15 being fixed to the body cylinder portion 50b, the drive-side magnet 20 and the pole piece 25 are axially aligned. Thus, the drive-side magnet 20 and the pole piece 25 are allowed to be axially aligned easily.

In this embodiment, the sealing cylinder portion 51b is made of a single non-magnetic body member. Thus, the pressure resistance can be ensured with the thin wall, and therefore magnetic reluctance can be reduced.

In this embodiment, the sealing top surface portion 51a, the sealing cylinder portion 51b, and the sealing bottom surface portion 51c of the sealing plate 51 are formed of a single non-magnetic body member. Thus, magnetic reluctance can be further reduced.

### Second Embodiment

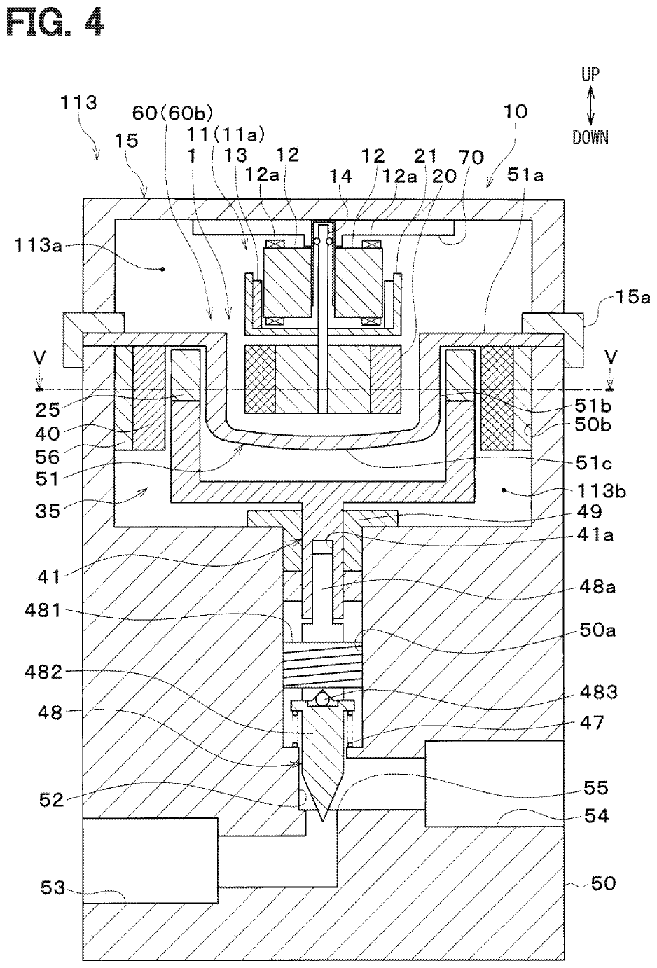

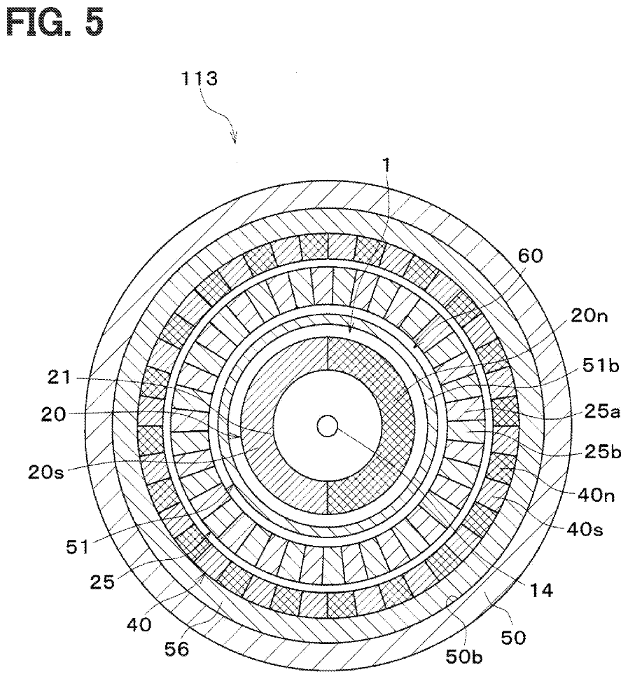

In the embodiment, the motor unit 11 is disposed inside the drive-side magnet 20. However, in this embodiment, as illustrated in FIG. 4 and FIG. 5, the motor unit 11 is disposed outside the drive-side magnet 20 and the side opposite to the driven side mechanism unit 35 with respect to the drive-side magnet 20.

This embodiment can also provide the operational effects similar to the embodiment.

### Third Embodiment

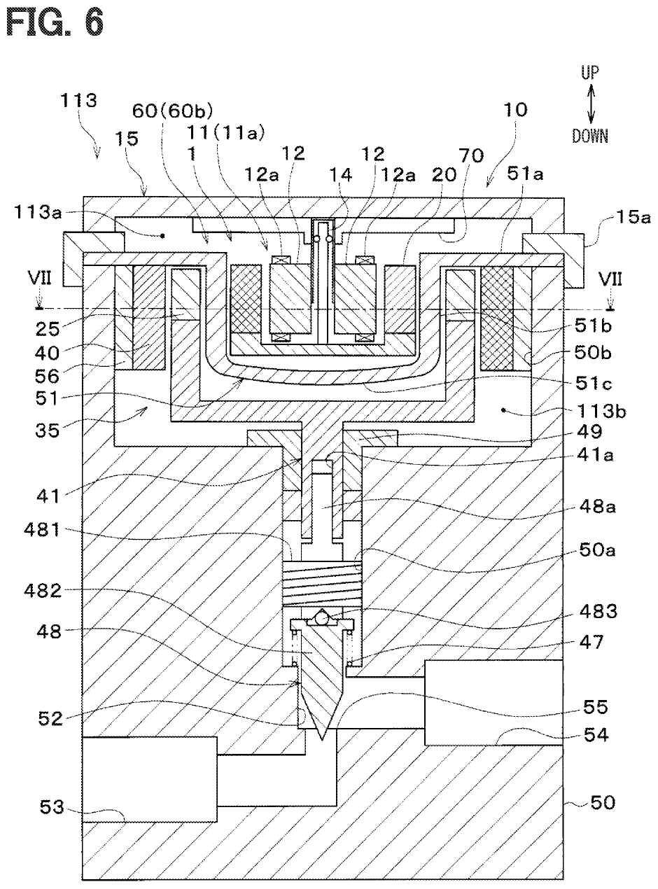

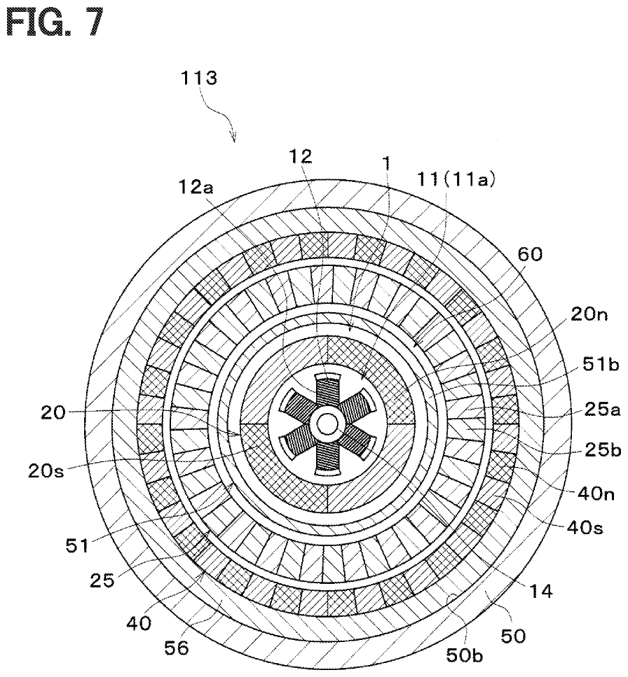

In the embodiments, the rotor 13 of the motor unit 11 and the drive-side magnet 20 of the magnetic gear 60b are different members, but in this embodiment, as illustrated in FIG. 6 and FIG. 7, the drive-side magnet 20 doubles as the rotor 13 of the motor unit 11.

That is, the stator 12 is disposed inside the drive-side magnet 20 to rotate the drive-side magnet 20 as a rotor. Accordingly, the number of components can be reduced and the configuration can be simplified.

### Fourth Embodiment

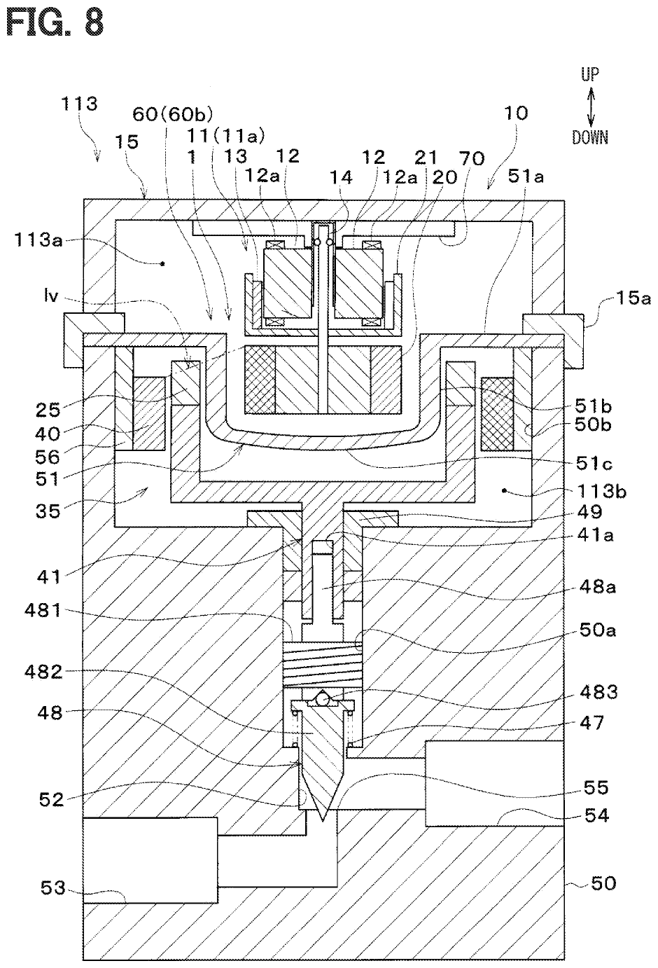

In this embodiment, as illustrated in FIG. 8, the pole piece 25 is upward an imaginary line lv connecting the upper end of the drive-side magnet 20 and the upper end of the stationary magnet 40.

In other words, in the axial direction of the drive-side magnet 20, the pole piece 25 is positioned on the side opposite to the bearing member 49 with respect to the imaginary line lv connecting the end portion on the side opposite to the bearing member 49 in the drive-side magnet 20 and the end portion on the side opposite to the bearing member 49 in the stationary magnet 40. Thus, a magnetic action of pushing the pole piece 25 and the rotating member 41 downward (the bearing member 49 side) occurs, and therefore the rotating member 41 can be stably rotated.

### Fifth Embodiment

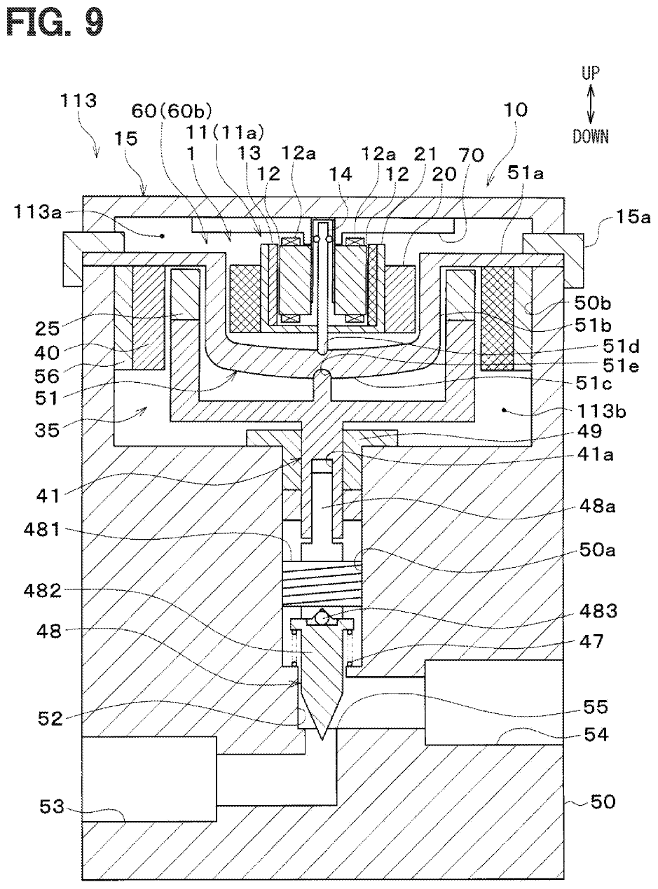

In this embodiment, as illustrated in FIG. 9, on the sealing bottom surface portion 51c of the sealing plate 51, a driving side shaft receiving portion 51d and a driven side shaft receiving portion 51e are formed. The driving side shaft receiving portion 51d rotatably supports the lower end portion of the shaft 14. The driven side shaft receiving portion 51e rotatably supports the upper end portion of the rotating member 41. Thus, the shaft 14 and the rotating member 41 can be stably rotated.

### Sixth Embodiment

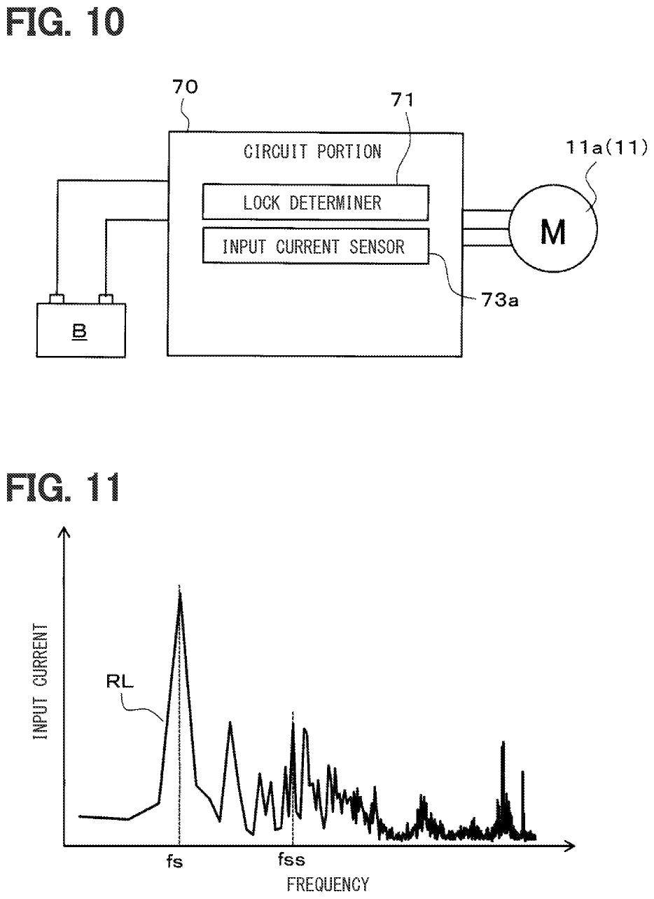

In this embodiment, a specific configuration of the circuit portion 70 of the first embodiment will be described. As illustrated in FIG. 10, to the circuit portion 70, the three-phase motors 11a as the motor unit 11 and a battery B are electrically connected. The battery B supplies various electrical devices of a vehicle with electric power and, for example, a chargeable/dischargeable secondary battery (a lithium-ion battery in this embodiment) is employed. The circuit portion 70 suppled with the input electric power from the battery B outputs drive current for driving the three-phase motors 11a.

The circuit portion 70 includes an electronic component, such as an ECU, for controlling the operation of the first expansion valve 113 as the electronic component and acts as a control unit regarding the operation of the first expansion valve 113. The circuit portion 70 includes a lock determiner 71. The lock determiner 71 constitutes a part of the control unit. In the operation of the first expansion valve 113, the lock determiner 71 determines whether the power generated in the driving side mechanism unit 10 is not transmitted to the driven side mechanism unit 35 and lock occurs in the driven side.

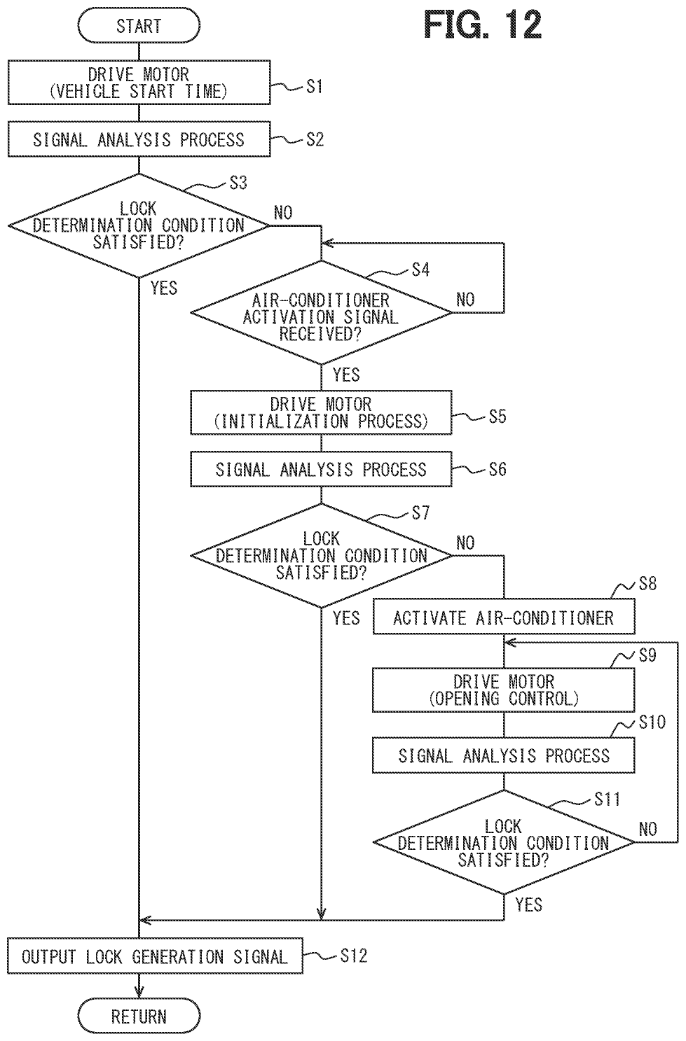

Specifically, the lock determiner 71 performs a lock determination control program depicted in the flowchart of FIG. 12 to determine whether the driven side locks and an operation error occurs in the valve element 48. The lock determination control program will be described later in detail.

To the circuit portion 70 according to this embodiment, an input current sensor 73a is connected. The input current sensor 73a is a sensor for measuring a value of input current input from the battery B to the circuit portion 70. In the first embodiment, the lock determiner 71 performs frequency analysis using high-speed Fourier transformation on the detection result of the input current sensor 73a and determines whether lock occurs in the driven side based on the analysis result.

Here, torque variation in a case where the magnetic gear 60b is in a standard state (that is, variation in the rotational load in the drive-side magnet 20) will be described. The standard state means a state of the power being preferably transmitted between the drive-side magnet 20 and the pole piece 25 and both of the drive-side magnet 20 and the pole piece 25 smoothly rotate.

In the standard state, the variation in the rotational load between the drive-side magnet 20 and the pole piece 25 in one rotation occurs at the points when the least common multiple of the number of magnetic pole pairs of the drive-side magnet 20 and the number of magnetic pole pairs of the stationary magnet 40 is reached.

For example, in the standard state, when the drive-side magnet 20 rotates by 21 clockwise in one second and the pole piece 25 rotates by one clockwise in one second, a relative rotation speed difference between the drive-side magnet 20 and the pole piece 25 is 20 rotations in one second. Accordingly, the variation in the rotational load in the standard state occurs at 200 Hz.

Subsequently, the variation in the rotational load when the magnetic gear 60b is in the lock state will be described. The lock state means a state in which while the drive-side magnet 20 freely rotates, the stationary magnet 40 is firmly fixed for any reason.

When the lock state is examined using the example of the above-described standard state, due to the action of the stationary magnet 40 and the pole piece 25, two-pole space harmonics are fixed in a void between the drive-side magnet 20 and the pole piece 25, and therefore a variation in the rotational load of 21 Hz occurs from the two-poles of the drive-side magnet and the rotation speed of the driving shaft.

As described above, the drive-side magnet 20 is integrated with the rotor 13 of the motor unit 11 via the interposition member 21 and the shaft 14. Accordingly, when the variation occurs in the rotational load in the lock state, the variation in the rotational load of the drive-side magnet 20 appears as the variation in the input current by speed feedback regarding the motor unit 11.

Therefore, by performing frequency analysis on the detection result of the input current sensor 73a by the lock determiner 71, lock occurred in the pole piece 25 or the like can be sensed.

The frequency regarding the variation in the input current occurred in the lock state differs from the frequency regarding the variation in the drive current to the motor unit 11. Thus, by identifying the frequency regarding the variation in the input current, the lock of the pole piece 25 or the like can be sensed.

It is found that lock occurs in the pole piece 25 or the like more easily by focusing on a certain specific frequency (hereinafter referred to as a specific frequency) when the result of the frequency analysis on the input electric power in the standard state is compared with an analysis result at lock RL.

FIG. 11 is a graph illustrating an example of the analysis result at lock RL obtained by performing the frequency analysis on the detection result of the input current sensor 73a by the lock determiner 71. As seen from the analysis result at lock RL illustrated in FIG. 11, the peak of the input current appears at a specific frequency fs due to the variation in the rotational load by lock of the pole piece 25 or the like.

The peak of the specific frequency fs can be further clearly identified by meeting a condition that the number of poles Pm of the motor unit 11 (for example, 8) differs from the number of poles Pin of the drive-side magnet 20 (for example, 2). The smaller the number of poles Pin of the drive-side magnet 20 is, the more the peak of the specific frequency fs can be clearly identified.

Thus, the power transmission device 1 according to this embodiment can compare the results of performing the frequency analysis on the input current in the lock determiner 71 between the standard state and the lock state to easily determine whether the lock occurs in the pole piece 25 or the like.

Subsequently, the content of the lock determination control in the power transmission device 1 according to this embodiment will be described with reference to FIG. 12. As described above, the first expansion valve 113 including the power transmission device 1 is mounted as a configuration device of the vapor compression refrigeration cycle 110 in the vehicle air conditioner 100 mounted on a vehicle. Therefore, the lock determiner 71 performs lock determination control at the point when the vehicle starts.

First, in Step S1 performed together with the start of the vehicle, the motor unit 11 constituting the driving side mechanism unit 10 is driven. At this time, the motor unit 11 operates the rotor 13 at a constant rotation.

When the process transitions to Step S2, a signal analysis process is performed on the detection result of the input current in Step S1. That is, the lock determiner 71 performs the frequency analysis using the high-speed Fourier transformation on the detection result of the input current detected at driving the motor unit 11 in Step S1.

In Step S3, whether the lock determination condition is met is determined. The lock determination condition means a condition under which the pole piece 25 or the like is determined to lock and means that the value of the input current in the specific frequency fs exceeds a reference value in the result of the frequency analysis on the input current in the first embodiment.

The reference value is determined with the standard state as a reference and is determined, for example, based on the value of the input current in the specific frequency fs in the result of the frequency analysis on the input current in the standard state.

When the value of the input current in the specific frequency fs exceeds the reference value in the result of the frequency analysis on the input current, the process transitions to Step S12, and when not, the process proceeds to Step S4.

In Step S4, whether an air-conditioner activation signal has been received is determined. The air-conditioner activation signal is a control signal output from an air conditioning control device constituting the vehicle air conditioner and is output, for example, when an operation of instructing start of the air conditioning operation is performed using an operation panel of a vehicle. When the air conditioner start signal is not received, the process is waited until the air conditioner start signal is received. When the air conditioner start signal is received, the process proceeds to Step S5.

When the process transitions to Step S5, as one of an initialization process in association with the start of air conditioning operation in the vehicle air conditioner, the motor unit 11 constituting the driving side mechanism unit 10 is driven. In this case as well, similar to Step S1, the motor unit 11 operates the rotor 13 at a constant rotation.

In Step S6, a signal analysis process is performed on the detection result of the input current in Step S5. That is, the lock determiner 71 performs the frequency analysis using the high-speed Fourier transformation on the detection result of the input current detected at driving the motor unit 11 in Step S5.

In Step S7, similar to Step S3, whether to meet the lock determination condition is determined. When the value of the input current in the specific frequency fs exceeds the reference value in the result of the frequency analysis on the input current, the process transitions to Step S12, and when not, the process proceeds to Step S8.

In Step S8, since it is determined that the lock does not occur in the pole piece 25 or the like from Step S4 to Step S7, the air conditioning operation in the vehicle air conditioner starts based on the air conditioner start signal.

At this time, in the vehicle air conditioner, an operation mode is selected based on a detection signal of a sensor group for air conditioning control and the operation signal from the operation panel, and a control signal for each of configuration devices of the vehicle air conditioner is output based on the selected operation mode. Accordingly, to achieve a degree of opening control based on the operation mode, a drive control signal of the motor unit 11 is output to the first expansion valve 113.

In Step S9, during the air conditioning operation of the vehicle air conditioner, the motor unit 11 constituting the driving side mechanism unit 10 is driven. Since the air conditioning operation of the vehicle air conditioner is performed, a control signal for achieving a reduced degree of opening according to a configuration of the air conditioning operation is output to the motor unit 11 of the first expansion valve 113, and the motor unit 11 causes the rotor 13 to actuate based on the control signal.

In Step S10, the signal analysis process is performed on the detection result of the input current in association with the degree of opening control of the first expansion valve 113 in Step S9. That is, the lock determiner 71 performs the frequency analysis using the high-speed Fourier transformation on the detection result of the input current detected at driving the motor unit 11 in Step S10.

In Step S11, similar to Step S3 and Step S7, whether to meet the lock determination condition is determined. When the value of the input current in the specific frequency fs exceeds the reference value in the result of the frequency analysis on the input current, the process transitions to Step S12, and when not, the process is returned to Step S9 and the lock determination of the pole piece 25 or the like during the air conditioning operation is continued.

When the process transitions to Step S12, a lock generation signal is output based on the determination of meeting the lock determination condition in Step S3, Step S7, and Step S11. The lock generation signal is indicative of a state in which the pole piece 25 and the rotating member 41 are firmly fixed to lock. After the lock signal is output, the lock determination control ends.

Examples of the output destination of the lock signal can include an air conditioning control device for vehicle air conditioner and a control device on the vehicle body side. When the lock signal is output to the air conditioning control device, the air conditioning control device stops the operation of the power transmission device 1 (that is, the operation of the first expansion valve 113). When the lock determination condition is met in Step S7 or Step S11, the air conditioning operation of the vehicle air conditioner may be stopped.

With the power transmission device 1 according to this embodiment, by performing the lock determination control depicted in FIG. 12, whether the lock occurs in the pole piece 25 or the like can be always monitored. That is, at the point when the lock occurs in the pole piece 25 or the like, the occurrence of lock can be recognized to provide countermeasure for releasing the lock.

As described above, with the power transmission device 1 according to this embodiment, the shaft 14 of the driving side mechanism unit 10 is contactlessly coupled to the rotating member 41 of the driven side mechanism unit 35 with the magnetic gear 60b as the contactless coupling portion 60 using the magnetic force. Accordingly, in a state of the drive-side magnet 20 rotating together with the shaft 14, when the pole piece 25 and the rotating member 41 lock, due to an influence of the magnetic force acting between the drive-side magnet 20 and the stationary magnet 40, the rotational loads of the shaft 14 and the drive-side magnet 20 periodically vary.

With the power transmission device 1, by using the variation of the rotational load in the driving side mechanism unit 10, whether lock occurs in the pole piece 25 in the driven side mechanism unit 35 separately partitioned can be determined.

As illustrated in FIG. 2 and FIG. 3, the contactless coupling portion 60 in the power transmission device 1 is constituted by the magnetic gear 60b in which the pole piece 25 is disposed between the drive-side magnet 20 and the stationary magnet 40. In the configuration, the number of poles Pm of the motor unit 11 differs from the number of poles Pin found by totaling the N-poles 20n and the S-poles 20s in the drive-side magnet 20.

In view of this, in the frequency analysis in the lock determination control depicted in FIG. 12, the specific frequency fs can be clearly discriminated, and the determination accuracy whether the lock determination condition is met can be improved.

As illustrated in FIG. 10 to FIG. 12, in the power transmission device 1 according to this embodiment, the frequency analysis on the input current of the motor unit 11 is performed. When the input current in the specific frequency fs exceeds the reference value, it is determined that the lock occurs in the pole piece 25.

Thus, based on the variation in the input current that is comparatively easily detected, the lock of the pole piece 25 in the driven side mechanism unit 35 divided from the driving side mechanism unit 10 can be accurately determined.

### Modification of Sixth Embodiment

In the sixth embodiment described above, with the number of poles Pm of the motor unit 11 differentiated from the number of poles Pin of the drive-side magnet 20 as the condition, using the value of the specific frequency fs in the analysis result at lock RL, whether the lock determination condition is met is determined.

As the modification according to the sixth embodiment, the lock determination condition can be configured such that values of the two kinds of the specific frequency fs and a specific frequency fss are used.

One condition when the configuration is employed includes that ½ of the number of poles Pm of the motor unit 11 differs from the least common multiple of ½ of the number of poles Pin in the drive-side magnet 20 and ½ of the number of poles Pf in the stationary magnet 40. By meeting the condition, whether the lock determination condition is met can be determined using the peak in the specific frequency fs in the analysis result at lock RL illustrated in FIG. 11.

By meeting the condition that the least common multiple of the number of poles Pm of the motor unit 11 and the number of slots Ns in the motor unit 11 differs from the least common multiple of ½ of the number of poles Pin in the drive-side magnet 20 and ½ of the number of poles Pf in the stationary magnet 40, the value of the specific frequency fss can be used. As illustrated in FIG. 11, the specific frequency fss indicates a frequency higher than the specific frequency fs.

Thus, in the lock determination condition, the determination with the value of the specific frequency fs and the determination with the value of the specific frequency fss are used f to allow determining whether the lock occurs in the pole piece 25 or the like with further high accuracy.

### Seventh Embodiment

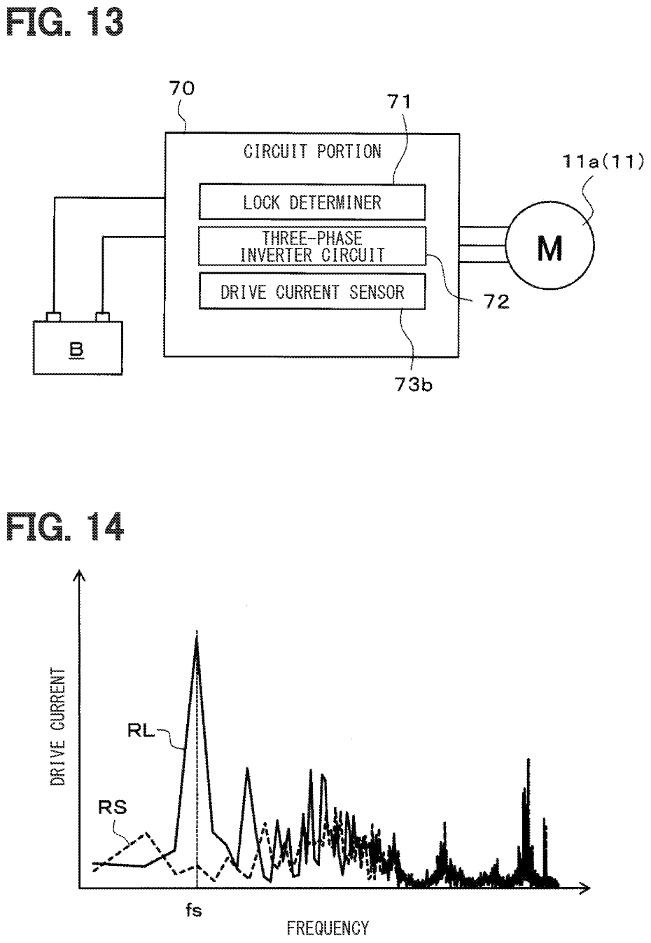

Subsequently, the seventh embodiment different from the above-described embodiments will be described with reference to FIG. 13 and FIG. 14. The seventh embodiment differs from the above-described embodiments in a determination method of determining that the lock occurs in the pole piece 25 or the like. Since the basic configurations of the driving side mechanism unit 10, the driven side mechanism unit 35, and the like are similar to those of the above-described embodiments, repeated description will be omitted.

As illustrated in FIG. 13, the power transmission device 1 according to the seventh embodiment employs the three-phase motors 11a as the motor unit 11 constituting the driving side mechanism unit 10. The circuit portion 70 according to the seventh embodiment includes the lock determiner 71, a three-phase inverter circuit unit 72, and a drive current sensor 73b.

The lock determiner 71 is similar to the sixth embodiment. The drive current sensor 73b is a sensor for detecting drive current supplied to the stator coil 12a in each phase in the three-phase motor 11a.

The three-phase inverter circuit unit 72 is a power converter circuit unit that converts DC power supplied from the battery B into AC power and is constituted by combining a plurality of Metal-Oxide-Semiconductor Field-Effect Transistors (MOSFETs).

As illustrated in FIG. 13, the three-phase inverter circuit unit 72 is electrically connected to the battery B and the three-phase motors 11a, converts the DC power of the battery B into three-phase current, and supplies the three-phase current to the stator coil 12a in each phase of the three-phase motor 11a.

The three-phase inverter circuit unit 72 according to the seventh embodiment includes a rectifier circuit unit (RCF) and an envelope detector (ENV). The rectifier circuit unit converts the three-phase signal into an analog signal to generate a three-phase AC current waveform and to perform full-wave rectification on the three-phase AC current waveform. The envelope detector detects an envelope of the full-wave rectification waveform and outputs the envelope.

Next, the lock determination control in the seventh embodiment will be described with reference to FIG. 14. In a case where the contactless coupling portion 60 is in the lock state, while the drive-side magnet 20 side rotates, the pole piece 25 stops. Accordingly, similar to the above-described embodiments, the variation in the rotational load between the drive-side magnet 20 and the pole piece 25 occurs at a constant cycle by the magnetic interaction.

Thus, in association with the variation in the rotational load, the rotation speed of the drive-side magnet 20 varies. Since the drive current of the motor unit 11 flows at a frequency synchronized with the rotation speed of the drive-side magnet 20 or the like, in association with the variation in the rotational load, the frequency of the drive current varies and the variation also appears in the envelope of the drive current.

In the seventh embodiment, when whether the lock determination condition is met is determined, the frequency analysis on the envelope of the drive current output from the envelope detector of the three-phase inverter circuit unit 72 is performed. FIG. 14 illustrates an example of the result of the frequency analysis on the envelope of the drive current. FIG. 14 illustrates a standard analysis result RS and the analysis result at lock RL. The standard analysis result RS indicates the result of the frequency analysis on the envelope of the drive current in the standard state. The analysis result at lock RL indicates the result of the frequency analysis on the envelope of the drive current in the lock state.

As described above, when the pole piece 25 or the like locks, the value of the envelope of the drive current varies in association with the variation in the rotational load. Thus, as illustrated in FIG. 14, in the specific frequency fs corresponding to the variation in the rotational load, the peak of the value in the analysis result at lock RL stands out more than the value of the standard analysis result RS and indicates the large value.

Therefore, in the fifth embodiment, by performing frequency analysis on the envelope of the drive current by the lock determiner 71, lock occurred in the pole piece 25 or the like can be sensed.

In the lock determination control in the fifth embodiment, the lock determination condition that the value of the envelope of the drive current in the specific frequency fs in the result of the frequency analysis on the envelope of the drive current exceeds the reference value is employed. The reference value in this case is determined with the standard state as a reference and, for example, is determined based on the value of the envelope of the drive current in the specific frequency fs in the result of the frequency analysis on the envelope of the drive current in the standard state (namely, the standard analysis result RS).

In this case, when the value of the envelope of the drive current in the specific frequency fs exceeds the reference value, it can be determined that the rotational load in the drive-side magnet 20 varies, the pole piece 25 or the like is firmly fixed, and the state is in the lock state. Otherwise, it can be determined that the power is appropriately transmitted between the drive-side magnet 20 and the pole piece 25 and the drive-side magnet 20 and the pole piece 25 are rotatable in the standard state.

As described above, the power transmission device 1 according to the seventh embodiment having the configuration in which the frequency analysis is performed on the envelope of the drive current of the three-phase motors 11a as well can obtain the effects similar to the above-described embodiments from the configuration similar to the above-described embodiments.

That is, the power transmission device 1 according to the seventh embodiment can accurately determine the lock of the pole piece 25 in the driven side mechanism unit 35 divided separately from the driving side mechanism unit 10 based on the variation in the envelope of the drive current.

### Eighth Embodiment

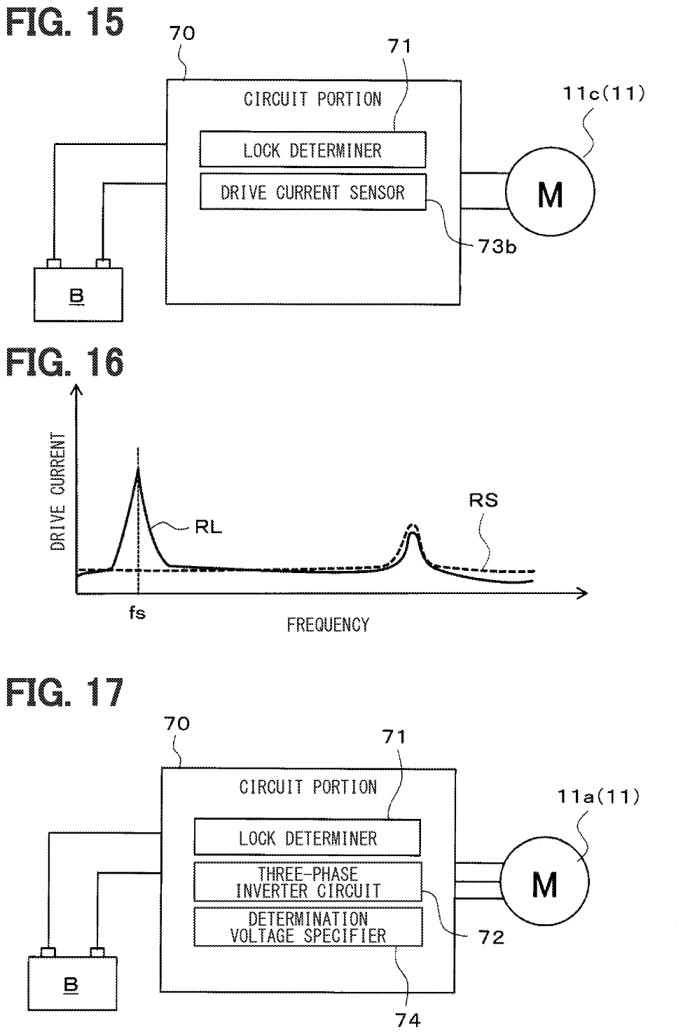

Next, the eighth embodiment different from the above-described embodiments will be described with reference to FIG. 15 and FIG. 16. The eighth embodiment differs from the above-described embodiments in a determination method of determining that the lock occurs in the motor unit 11, the pole piece 25, or the like. Since the other configurations, such as the driven side mechanism unit 35, are similar to those of the above-described embodiments, repeated description will be omitted.

As illustrated in FIG. 15, the power transmission device 1 according to the eighth embodiment employs a DC motor 11c as the motor unit 11. The DC motor 11c is a DC commutator motor including a commutator and a brush.

The circuit portion 70 according to the eighth embodiment includes the lock determiner 71 and the drive current sensor 73b. To the circuit portion 70, the battery B, and the DC motor 11c are electrically connected. The lock determiner 71 is similar to the above-described embodiments. The drive current sensor 73b according to the eighth embodiment is a sensor for detecting the drive current supplied to the DC motor 11c.

Next, the lock determination control in the eighth embodiment will be described with reference to FIG. 16. The power transmission device 1 according to the sixth embodiment employs the DC motor 11c including a commutator and a brush as the motor unit 11. Accordingly, in the DC motor 11c, to keep the rotation direction of the rotor 13 in the predetermined direction, at the point when a rotation phase of the rotor 13 becomes a predetermined phase, the commutator and the brush switch the direction of current.

Therefore, when the frequency analysis is performed on the drive current of the DC motor 11c, as illustrated in FIG. 16, the peaks caused by current switching by the commutator and the brush occur in both of the standard analysis result RS and the analysis result at lock RL.

In the eighth embodiment as well, when the contactless coupling portion 60 is in the lock state, the variation in the rotational load between the drive-side magnet 20 and the pole piece 25 occurs at a constant cycle by the magnetic interaction similar to the above-described embodiments. The cycle at which the rotational load varies differs from the cycle regarding the current switching by the commutator and the brush, and therefore the peak of the drive current regarding the analysis result at lock RL in the specific frequency fs can be clearly discriminated from the value of the drive current regarding the standard analysis result RS.

Therefore, in the eighth embodiment, by performing the frequency analysis on the drive current of the DC motor 11c by the lock determiner 71, lock occurred in the pole piece 25 or the like can be sensed.

In the lock determination control in the eighth embodiment, the lock determination condition that the drive current in the specific frequency fs in the result of the frequency analysis on the drive current of the DC motor 11c exceeds the reference value is employed. The reference value in this case is determined with the standard state as a reference and, for example, is determined based on the value of the drive current in the specific frequency fs in the result of the frequency analysis on the drive current of the DC motor 11c in the standard state (namely, the standard analysis result RS).

In this case, when the value of the drive current of the DC motor 11c in the specific frequency fs exceeds the reference value, it can be determined that the rotational load in the drive-side magnet 20 varies, the pole piece 25 or the like is firmly fixed, and the state is in the lock state. Otherwise, it can be determined that the power is appropriately transmitted between the drive-side magnet 20 and the stationary magnet 40 and the drive-side magnet 20 and the pole piece 25 are rotatable in the standard state.

As described above, the power transmission device 1 according to the eighth embodiment having the configuration in which the frequency analysis is performed on the drive current of the DC motor 11c as well can obtain the effects similar to the above-described embodiments from the configuration similar to the above-described embodiments.

That is, the power transmission device 1 according to the eighth embodiment can accurately determine the lock of the pole piece 25 in the driven side mechanism unit 35 divided separately from the driving side mechanism unit 10 based on the variation in the drive current of the DC motor 11c.

### Ninth Embodiment

Subsequently, the ninth embodiment different from the above-described embodiments will be described with reference to FIG. 17 and FIG. 18. The ninth embodiment differs from the above-described embodiments in a determination method of determining that the lock occurs in the pole piece 25 or the like. Since the other configurations, such as the driven side mechanism unit 35, are similar to those of the above-described embodiments, repeated description will be omitted.

As illustrated in FIG. 17, the power transmission device 1 according to the ninth embodiment employs the three-phase motors 11a as the motor unit 11 constituting the driving side mechanism unit 10. The circuit portion 70 according to the seventh embodiment includes the lock determiner 71, the three-phase inverter circuit unit 72, and a determination voltage specifier 74.

The lock determiner 71 is similar to the above-described embodiments. Similar to the above-described embodiments, the three-phase inverter circuit unit 72 is electrically connected to the battery B and the three-phase motors 11a, converts the DC power of the battery B into three-phase current, and supplies the three-phase current to the stator coil 12a in each phase of the three-phase motor 11a.

The three-phase inverter circuit unit 72 according to the ninth embodiment determines a duty ratio, which is a ratio between on time and off time of the motor unit 11, and supplies electric power to the DC motor 11c based on the determined duty ratio. That is, PWM control is performed on the three-phase motors 11a.

Specifically, a predetermined triangular-wave is compared with determination voltage and the duty ratio of the voltage supplied to the three-phase motors 11a is determined by the ratio between a period during which the triangular-wave is higher than the determination voltage and the period during which the triangular-wave is lower than the determination voltage. The determination voltage specifier 74 identifies the determination voltage for determining the duty ratio. For example, when the triangular-wave and the determination voltage are input to a comparator, the determination voltage specifier 74 identifies the value of the determination voltage input to the comparator.

Next, the lock determination control in the ninth embodiment will be described with reference to FIG. 18. As described above, the actuation of the three-phase motors 11a in the ninth embodiment is controlled by PWM control. Therefore, the higher the duty ratio is, the faster the rotation speed of the rotor 13 in the three-phase motors 11a becomes. The lower the duty ratio is, the slower the rotation speed of the rotor 13 becomes.

Thus, in the ninth embodiment, when the pole piece 25 or the like is firmly fixed and enters the lock state and the rotational load regarding the drive-side magnet 20 varies, the duty ratio varies following the variation in the rotational load. As described above, since the duty ratio is determined by comparison between the triangular-wave and the determination voltage, the determination voltage varies at the same cycle as the variation in the duty ratio.

On the other hand, since a large variation does not occur in the rotational load between the drive-side magnet 20 and the pole piece 25 in the standard state, a large variation does not occur in the duty ratio or the determination voltage as well.

The lock determination control according to the ninth embodiment performs frequency analysis on the determination voltage. As illustrated in FIG. 18, in the analysis result at lock RL, the peak of the determination voltage appears in the specific frequency fs corresponding to the variation in the rotational load. On the other hand, in the standard state, the rotational load does not largely vary and the drive-side magnet 20 and the pole piece 25 appropriately rotate. Thus, in the standard analysis result RS, the value of the determination voltage does not largely vary in the specific frequency fs.

Therefore, in the ninth embodiment, by performing the frequency analysis on the determination voltage regarding the PWM control by the lock determiner 71, lock occurred in the pole piece 25 or the like can be sensed.

In the lock determination control in the ninth embodiment, the lock determination condition that the determination voltage in the specific frequency fs in the result of the frequency analysis on the determination voltage regarding the PWM control exceeds the reference value is employed. The reference value in this case is determined with the standard state as a reference and, for example, is determined based on the value of the determination voltage in the specific frequency fs in the result of the frequency analysis on the determination voltage in the standard state (namely, the standard analysis result RS).

In this case, when the value of the determination voltage in the specific frequency fs exceeds the reference value, it can be determined that the rotational load in the drive-side magnet 20 varies, the pole piece 25 or the like is firmly fixed, and the state is in the lock state. Otherwise, it can be determined that the power is appropriately transmitted between the drive-side magnet 20 and the pole piece 25 and the drive-side magnet 20 and the pole piece 25 are rotatable in the standard state.

As described above, the power transmission device 1 according to the ninth embodiment having the configuration in which the frequency analysis is performed on the determination voltage regarding the PWM control of the motor unit 11 as well can obtain the effects similar to the above-described embodiments from the configuration similar to the above-described embodiments.

That is, the power transmission device 1 according to the ninth embodiment can accurately determine the lock of the pole piece 25 in the driven side mechanism unit 35 divided separately from the driving side mechanism unit 10 based on the variation in the determination voltage.

### Tenth Embodiment

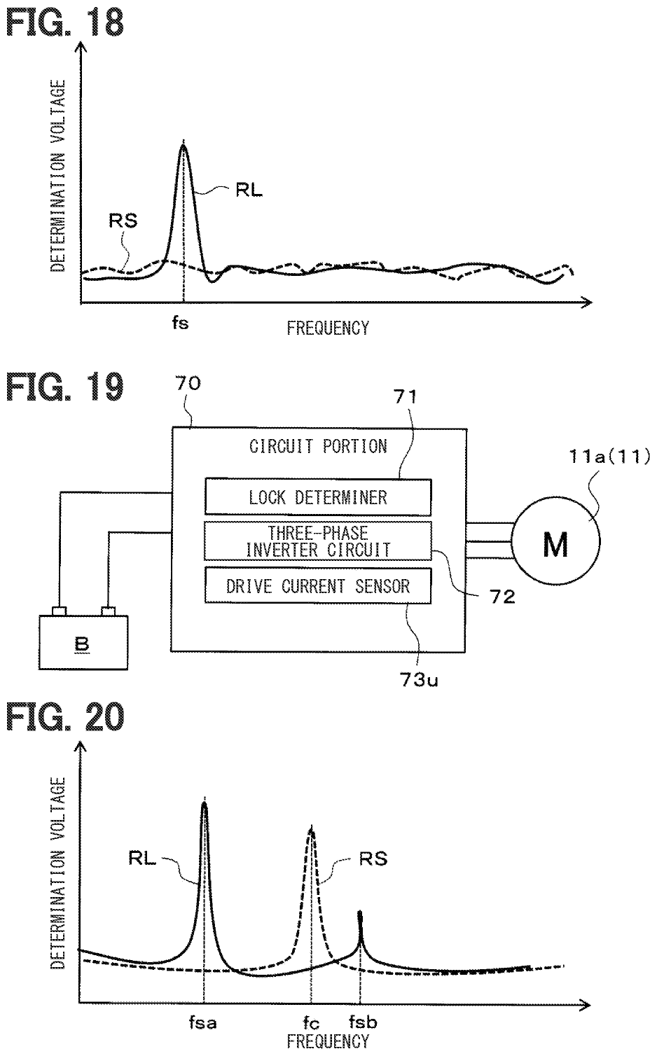

Next, the tenth embodiment different from the above-described embodiments will be described with reference to FIG. 19 and FIG. 20. The tenth embodiment differs from the above-described embodiments in a determination method of determining that the lock occurs in the pole piece 25 or the like. Since the other configurations, such as the driven side mechanism unit 35, are similar to those of the above-described embodiments, repeated description will be omitted.

As illustrated in FIG. 19, the power transmission device 1 according to the tenth embodiment employs the three-phase motors 11a as the motor unit 11 constituting the driving side mechanism unit 10. The circuit portion 70 according to the tenth embodiment includes the lock determiner 71, the three-phase inverter circuit unit 72, and a drive current sensor 73u.

The lock determiner 71 is similar to the above-described embodiments. Similar to the above-described embodiments, the three-phase inverter circuit unit 72 is electrically connected to the battery B and the three-phase motors 11a, converts the DC power of the battery B into three-phase current, and supplies the three-phase current to the stator coil 12a in each phase of the three-phase motor 11a.

The drive current sensor 73u according to the tenth embodiment is a sensor that detects drive current of a U-phase among the U-phase, a V-phase, and a W-phase to the three-phase motors 11a. The drive current sensor 73b only needs to detect the drive current regarding any one phase among the drive current to the three-phase motors 11a.

Next, the lock determination control in the tenth embodiment will be described with reference to FIG. 20. In a case where the contactless coupling portion 60 is in the lock state, while the drive-side magnet 20 side rotates, the pole piece 25 stops. Accordingly, similarly to the above-described embodiments, the variation in the rotational load between the drive-side magnet 20 and the pole piece 25 occurs at a constant cycle by the magnetic interaction.

Since the pole piece 25 stops, when the drive-side magnet 20 rotates, a state in which magnetism acts so as to attract and a state in which the magnetism acts so as to repel occur between the drive-side magnet 20 and the stationary magnet 40. The rotation speed of the drive-side magnet 20 side accelerates and decelerates by the influence of the attraction and repulsion of the magnetism between the drive-side magnet 20 and the stationary magnet 40. Since the drive current of the motor unit 11 flows at a frequency synchronized with the rotation speed of the drive-side magnet 20 or the like, in association with the variation in the rotational load, the frequency of the drive current varies.

In the following description, a specific frequency when the rotation speed slows due to the influence of the magnetic force with the stationary magnet 40 is referred to as a first specific frequency fsa and a specific frequency when the rotation speed becomes fast due to the influence of the magnetic force with the stationary magnet 40 is referred to as a second specific frequency fsb.

On the other hand, in the standard state, the drive-side magnet 20 and the pole piece 25 rotate at a constant rotation speed, and therefore the frequency of the drive current is also constant. A frequency corresponding to the constant rotation speed in the standard state is referred to as a standard frequency fc.

In the lock determination control according to the tenth embodiment, the frequency analysis is performed on the drive current in any one phase to the three-phase motor 11a. As illustrated in FIG. 20, in the standard analysis result RS, the peak of the drive current appears in the standard frequency fc.

On the other hand, in the analysis result at lock RL, the peak of the drive current appears in the first specific frequency fsa smaller than the standard frequency fc. The drive current in the first specific frequency fsa indicates the value at the time point when the rotation speed of the drive-side magnet 20 slows due to the variation in the rotational load.

In the analysis result at lock RL, the peak of the drive current appears in the second specific frequency fsb larger than the standard frequency fc. The drive current in the second specific frequency fsb indicates the value at the time point when the rotation speed of the drive-side magnet 20 becomes fast due to the variation in the rotational load.

As described above, the drive-side magnet 20 and the pole piece 25 rotate at the constant rotation speed in the standard state, and therefore the peak appears in the standard frequency fc and the peak does not appear in the first specific frequency fsa or the second specific frequency fsb.

Accordingly, in the tenth embodiment, the frequency analysis is performed on the drive current in any one phase to the three-phase motor 11a and the values of the first specific frequency fsa and the second specific frequency fsb are compared to ensure detecting the lock of the pole piece 25 or the like.

In the lock determination control in the tenth embodiment, the lock determination condition that the drive current in the first specific frequency fsa and the second specific frequency fsb in the result of the frequency analysis on the drive current in any one phase of the three-phase motor 11a exceeds the reference value is employed.

The reference value in this case is determined with the standard state as a reference and, for example, the reference value regarding the first specific frequency fsa is determined based on the value of the drive current in the first specific frequency fsa in the standard analysis result RS. The reference value regarding the second specific frequency fsb is determined based on the value of the drive current in the second specific frequency fsb in the standard analysis result RS.

When the value of the drive current in the first specific frequency fsa exceeds the reference value, it can be determined that the rotational load in the drive-side magnet 20 varies, the pole piece 25 or the like is firmly fixed, and the state is in the lock state. Otherwise, it can be determined that the power is appropriately transmitted between the drive-side magnet 20 and the pole piece 25 and the drive-side magnet 20 and the pole piece 25 are rotatable in the standard state.

By determining that the lock occurs in the pole piece 25 or the like when the values of the drive current of both of the first specific frequency fsa and the second specific frequency fsb exceed the respective reference values, the lock state can be more reliably sensed.

In any one of the first specific frequency fsa and the second specific frequency fsb, when the values of the drive current exceed the respective reference values, it may be determined that the lock state occurs.

As described above, the power transmission device 1 according to the tenth embodiment having the configuration in which the frequency analysis is performed on the drive current in any one phase of the three-phase motors 11a as well can obtain the effects similar to the above-described embodiments from the configuration similar to the above-described embodiments.

That is, the power transmission device 1 according to the tenth embodiment can accurately determine the lock of the pole piece 25 in the driven side mechanism unit 35 divided separately from the driving side mechanism unit 10 based on the variation in the drive current in any one phase of the three-phase motor 11a.

### Eleventh Embodiment

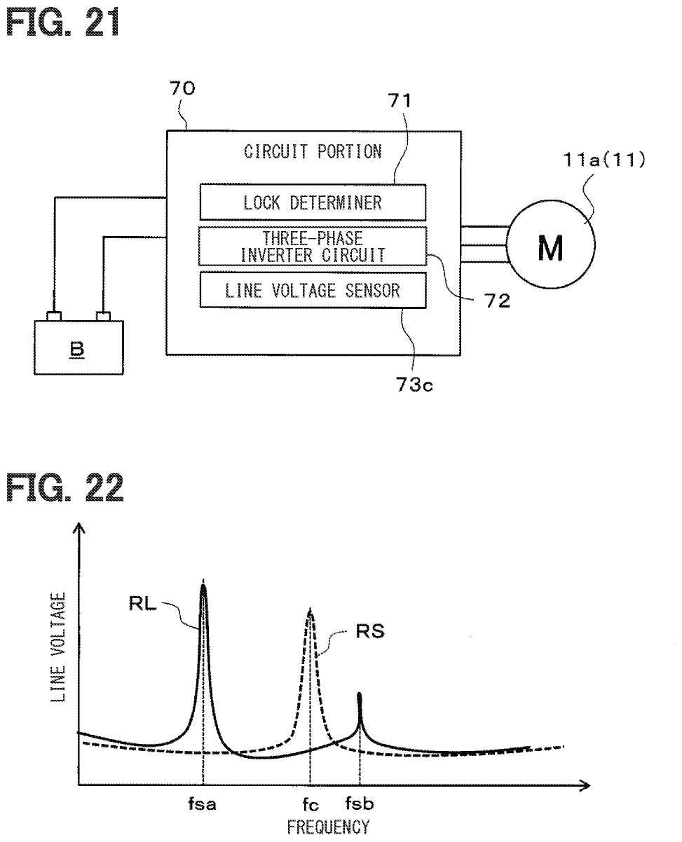

Subsequently, the eleventh embodiment different from the above-described embodiments will be described with reference to FIG. 21 and FIG. 22. The eleventh embodiment differs from the above-described embodiments in a determination method of determining that the lock occurs in the pole piece 25 or the like. Since the other configurations, such as the driven side mechanism unit 35, are similar to those of the above-described embodiments, repeated description will be omitted.

As illustrated in FIG. 21, the power transmission device 1 according to the eleventh embodiment employs the three-phase motors 11a as the motor unit 11 constituting the driving side mechanism unit 10. The circuit portion 70 according to the eleventh embodiment includes the lock determiner 71, the three-phase inverter circuit unit 72, and a line voltage sensor 73c.

The lock determiner 71 is similar to the above-described embodiments. Similar to the above-described embodiments, the three-phase inverter circuit unit 72 is electrically connected to the battery B and the three-phase motors 11a, converts the DC power of the battery B into three-phase current, and supplies the three-phase current to the stator coil 12a in each phase of the three-phase motor 11a.

The line voltage sensor 73c detects the value of voltage between any of the two phases among the three phases to the three-phase motors 11a. The line voltage sensor 73c, for example, detects the value of line voltage between the U-phase and the V-phase among the U-phase, the V-phase, and the W-phase to the three-phase motors 11a.

Next, the lock determination control in the eleventh embodiment will be described with reference to FIG. 22. As described above, in the lock state, the variation in the rotational load between the drive-side magnet 20 and the pole piece 25 occurs at a constant cycle by the magnetic interaction similar to the above-described embodiments.

Since the pole piece 25 stops, when the drive-side magnet 20 rotates, a state in which magnetism acts so as to attract and a state in which the magnetism acts so as to repel occur between the drive-side magnet 20 and the stationary magnet 40. Thus, the rotation speed of the drive-side magnet 20 side accelerates and decelerates by the influence of the attraction and repulsion of the magnetism between the drive-side magnet 20 and the stationary magnet 40. Since the drive current of the motor unit 11 flows at a frequency synchronized with the rotation speed of the drive-side magnet 20 or the like, in association with the variation in the rotational load, the line voltage between any of the two phases in the three-phase motors 11a varies.

In the lock determination control according to the eleventh embodiment, the frequency analysis is performed on the line voltage in any of the two phases to the three-phase motors 11a. As illustrated in FIG. 22, in the standard analysis result RS, the peak of the line voltage appears in the standard frequency fc.

On the other hand, in the analysis result at lock RL, the peaks of the drive current appear in the first specific frequency fsa and the second specific frequency fsb. The line voltage in the first specific frequency fsa indicates the value at the time point when the rotation speed of the drive-side magnet 20 slows due to the variation in the rotational load. The line voltage in the second specific frequency fsb indicates the value at the time point when the rotation speed of the drive-side magnet 20 becomes fast due to the variation in the rotational load.

As described above, the drive-side magnet 20 and the pole piece 25 rotate at the constant rotation speed in the standard state, and therefore the peak appears in the standard frequency fc and the peak does not appear in the first specific frequency fsa or the second specific frequency fsb.

Accordingly, in the eleventh embodiment, the frequency analysis is performed on the line voltage between any of the two phases to the three-phase motors 11a and the values of the first specific frequency fsa and the second specific frequency fsb are compared to ensure detecting the lock of the pole piece 25 or the like.

In the lock determination control in the eleventh embodiment, the lock determination condition that the line voltage in the first specific frequency fsa and the second specific frequency fsb in the result of the frequency analysis on the line voltage between any of the two phases of the three-phase motors 11a exceeds the reference value is employed.

The reference value in this case is determined with the standard state as a reference and, for example, the reference value regarding the first specific frequency fsa is determined based on the value of the line voltage in the first specific frequency fsa in the standard analysis result RS. The reference value regarding the second specific frequency fsb is determined based on the value of the line voltage in the second specific frequency fsb in the standard analysis result RS. When the value of the line voltage in the first specific frequency fsa exceeds the reference value, the variation in the rotational load occurs in the drive-side magnet 20 and it can be determined that the pole piece 25 or the like is in the lock state. Otherwise, it can be determined that the drive-side magnet 20 and the pole piece 25 are rotatable in the standard state.

By determining that the lock occurs in the pole piece 25 or the like when the values of the line voltage of both of the first specific frequency fsa and the second specific frequency fsb exceed respective reference values, the lock state can be more reliably sensed.

As described above, the power transmission device 1 according to the eleventh embodiment having the configuration in which the frequency analysis is performed on the line voltage of the three-phase motors 11a as well can obtain the effects similar to the above-described embodiments from the configuration similar to the above-described embodiments.

That is, the power transmission device 1 according to the eleventh embodiment can accurately determine the lock of the pole piece 25 in the driven side mechanism unit 35 divided separately from the driving side mechanism unit 10 based on the variation in the line voltage of the three-phase motors 11a.

### Twelfth Embodiment

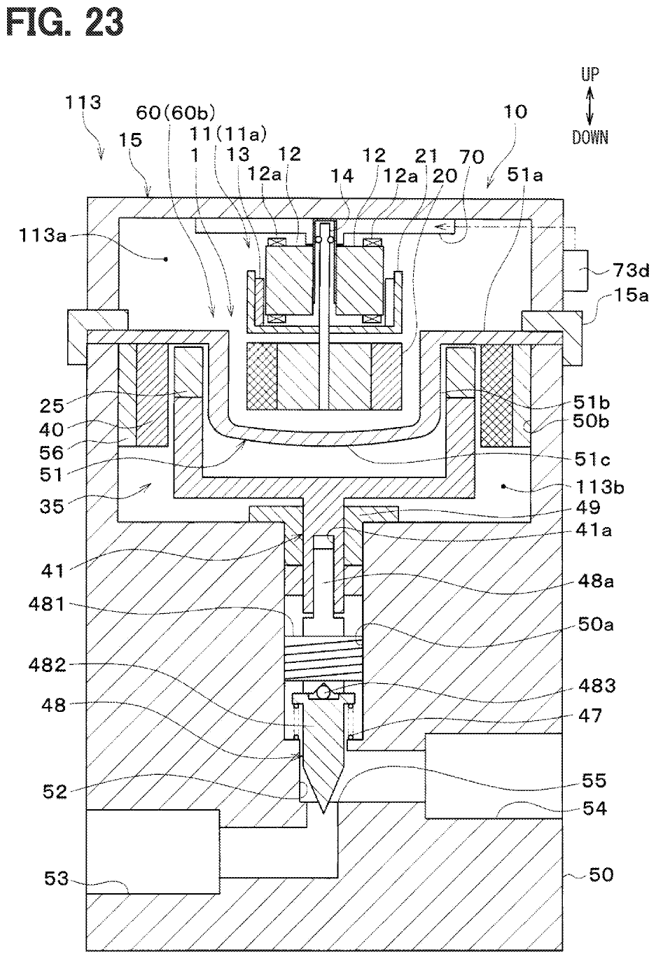

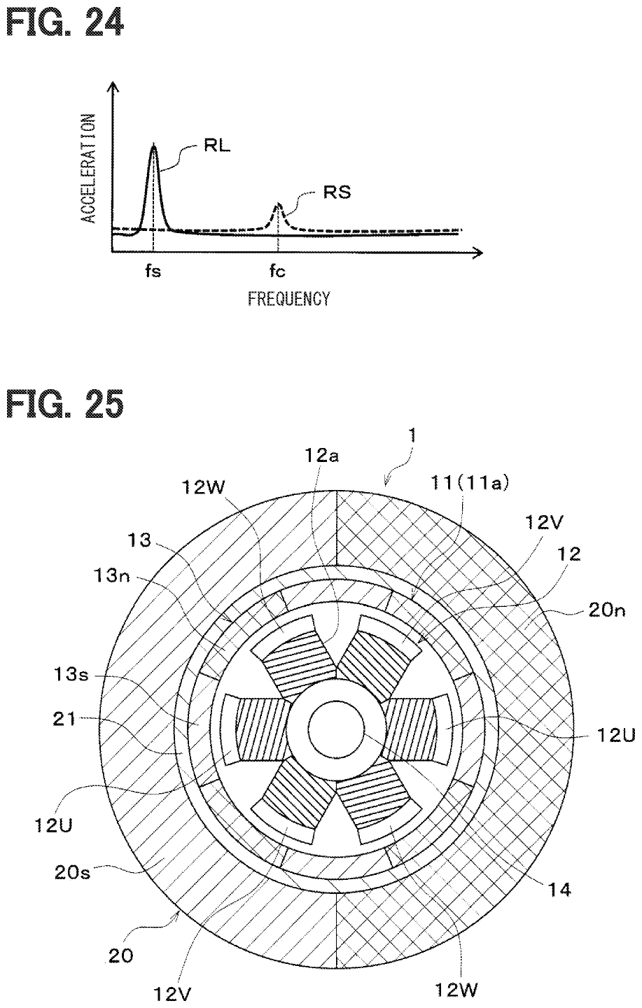

Next, the twelfth embodiment different from the above-described embodiments will be described with reference to FIG. 23 and FIG. 24. The twelfth embodiment differs from the above-described embodiments in a determination method of determining that the lock occurs in the pole piece 25 or the like. Since the other configurations, such as the driven side mechanism unit 35, are similar to those of the above-described embodiments, repeated description will be omitted.

In the power transmission device 1 according to the twelfth embodiment, the circuit portion 70 includes the lock determiner 71 and an acceleration sensor 73d. As illustrated in FIG. 23, the acceleration sensor 73d is disposed on the motor case 15 of the driving side mechanism unit 10 to detect a change in acceleration occurred in the driving side mechanism unit 10. Therefore, the power transmission device 1 according to the twelfth embodiment can detect a vibration occurred by actuation of the motor unit 11 of the driving side mechanism unit 10 by the acceleration sensor 73d.

Next, the lock determination control in the twelfth embodiment will be described with reference to FIG. 24. As described above, in the standard state, the rotational load hardly varies between the drive-side magnet 20 and the pole piece 25 and the drive-side magnet 20 and the pole piece 25 integrally rotate. That is, the driving side mechanism unit 10 vibrates at a constant cycle by integrally rotating the drive-side magnet 20 and the pole piece 25.

On the other hand, in the lock state, since the pole piece 25 stops, the rotational load varies by the magnetic interaction with the stationary magnet 40 when the drive-side magnet 20 rotates. Since the variation in the rotational load changes the rotation speeds of the drive-side magnet 20 and the shaft 14, the driving side mechanism unit 10 including the motor unit 11 vibrates caused by the variation in the rotational load.

The cycle of the vibration in the lock state differs from the vibration cycle in the standard state due to the influence of the magnetism between the drive-side magnet 20 and the stationary magnet 40. Thus, by the acceleration sensor 73d analyzing the cycle of the vibration in the driving side mechanism unit 10, whether the lock occurs in the pole piece 25 or the like can be determined.

The lock determination control according to the twelfth embodiment performs the frequency analysis on the detection signal of the acceleration sensor 73d. As illustrated in FIG. 24, the peak of the acceleration appears in the standard frequency fc in the standard analysis result RS. The standard frequency fc corresponds to the cycle of the vibration by the rotation of the drive-side magnet 20 and the pole piece 25 in the standard state.

On the other hand, in the analysis result at lock RL, the peak of the acceleration appears in the specific frequency fs. The peak of the acceleration in the specific frequency fs is caused by the vibration of the driving side mechanism unit 10 due to the variation in the rotational load.

As described above, the drive-side magnet 20 and the pole piece 25 rotate at the constant rotation speed in the standard state, and therefore the peak appears in the standard frequency fc and the peak of the acceleration does not appear in the specific frequency fs.

Accordingly, in the twelfth embodiment, the frequency analysis is performed on the detection signal of the acceleration sensor 73d and the values of the specific frequencies fs are compared to ensure detecting the lock of the pole piece 25 or the like.

In the lock determination control in the twelfth embodiment, the lock determination condition that the value of the acceleration in the specific frequency fs in the result of the frequency analysis on the detection signal of the acceleration sensor 73d exceeds the reference value is employed. The reference value in this case is determined with the standard state as a reference and is, for example, determined based on the value of the acceleration in the specific frequency fs in the standard analysis result RS.

When the value of the acceleration in the specific frequency fs exceeds the reference value, the variation in the rotational load occurs in the drive-side magnet 20 and it can be determined that the pole piece 25 or the like is in the lock state. Otherwise, it can be determined that the drive-side magnet 20 and the pole piece 25 are rotatable in the standard state.

As described above, the power transmission device 1 according to the twelfth embodiment having the configuration in which the frequency analysis is performed on the acceleration detected by the acceleration sensor 73d as well can obtain the effects similar to the above-described embodiments from the configuration similar to the above-described embodiments.

That is, the power transmission device 1 according to the twelfth embodiment can accurately determine the lock of the pole piece 25 in the driven side mechanism unit 35 divided separately from the driving side mechanism unit 10 based on the variation in the acceleration detected by the acceleration sensor 73d.

### Thirteenth Embodiment

In the first embodiment and the like, the stator 12 and the rotor 13 of the motor unit 11 are disposed inside the drive-side magnet 20 of the magnetic gear 60b. Accordingly, the stator 12, the rotor 13, and the drive-side magnet 20 are arranged in the radial direction, and therefore induced voltages occur in the motor unit 11 by the drive-side magnet 20 and becomes rotational resistance.

In consideration of the point, an object of this embodiment is to suppress the rotational resistance in the motor unit 11 of the first expansion valve 113 by the magnetic gear 60b of the power transmission device 1.

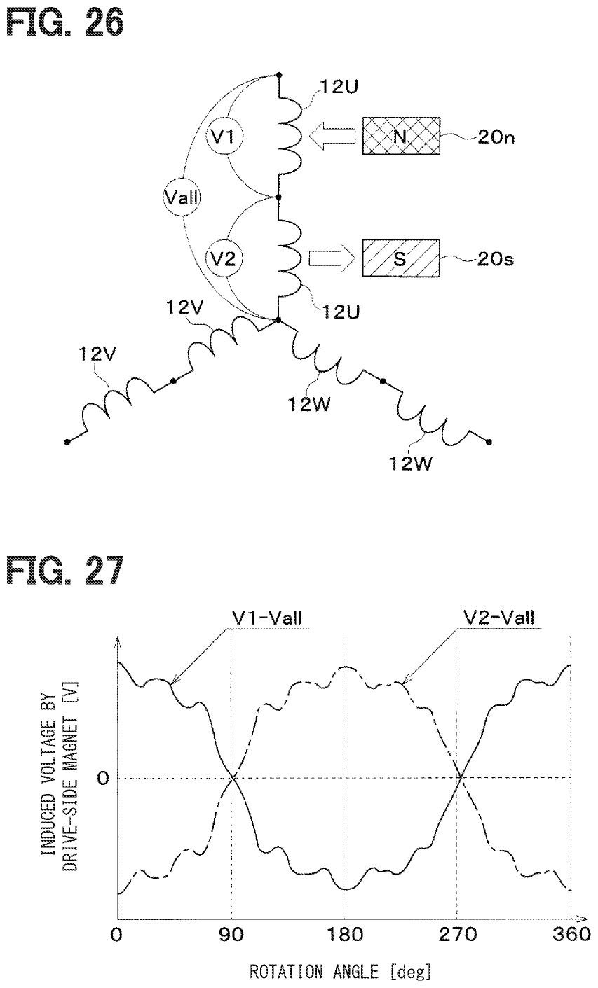

As illustrated in FIG. 25 and FIG. 26, the motor unit 11 of this embodiment is the three-phase motors 11a. The cylindrical rotor 13 is disposed outside in the radial direction of the stator 12.

The number of slots Ns of the stator 12 is 6. Accordingly, the phases of the U-phase, the V-phase, and the W-phase each have two slots. The six slots of the stator 12 are disposed in the order from a U-phase slot 12U, a V-phase slot 12V, a W-phase slot 12W, the U-phase slot 12U, the V-phase slot 12V, and the W-phase slot 12W in the circumferential direction. The six slots 12U, 12V, 12W, 12U, 12V, 12W of the stator 12 are equally disposed in the circumferential direction. The six slots 12U, 12V, 12W, 12U, 12V, 12W of the stator 12 are disposed at every 60 degrees in the circumferential direction.

Accordingly, among the six slots 12U, 12V, 12W, 12U, 12V, 12W of the stator 12, a pair of the slots in the same phase are disposed at every 180 degrees in the circumferential direction. In other words, among the six slots 12U, 12V, 12W, 12U, 12V, 12W of the stator 12, the pair of slots in the same phase are disposed at positions facing one another.

Winding directions of the stator coils 12a of the stator 12 are in the mutually same direction in all slots.

The drive-side magnet 20 is disposed coaxially with the rotor 13 outside in the radial direction of the rotor 13.

The number of poles Pin of the drive-side magnet 20 is 2. Accordingly, the number of pole pairs of the drive-side magnet 20 is 1. The N-poles 20n and the S-poles 20s of the drive-side magnet 20 are disposed alternatingly and equally in the circumferential direction. The N-pole 20n and the S-pole 20s of the drive-side magnet 20 are disposed at every 180 degrees in the circumferential direction.

In the two slots in each of the phases of the three-phase motors 11a, the positional relationship between the N-pole 40n and the S-pole 40s of the drive-side magnet 20 becomes opposite to one another, and the magnetic flux of the drive-side magnet 20 becomes the opposite phase.

Therefore, as illustrated in FIG. 27, in the two slots in one phase of the three-phase motors 11a, the induced voltages by the drive-side magnet 20 become to have opposite phases and cancel one another, and therefore the sum of the induced voltages in one phase of the three-phase motors 11a becomes 0. Similarly to the other two phases, the sum of the induced voltages becomes 0.

Accordingly, in the slots in each phase, the induced voltages by the drive-side magnet 20 cancel one another, and therefore the rotational resistance in the motor unit 11 can be reduced.

In this embodiment, the drive-side magnet 20 is configured such that the induced voltages generated in the stator coils 12a by the drive-side magnet 20 cancel one another in each phase. In other words, the drive-side magnet 20 is configured such that the sum of the induced voltages generated in the stator coils 12a by the drive-side magnet 20 in each of the phases becomes 0. Thus, the rotational resistance in the motor unit 11 can be reduced.

### Fourteenth Embodiment

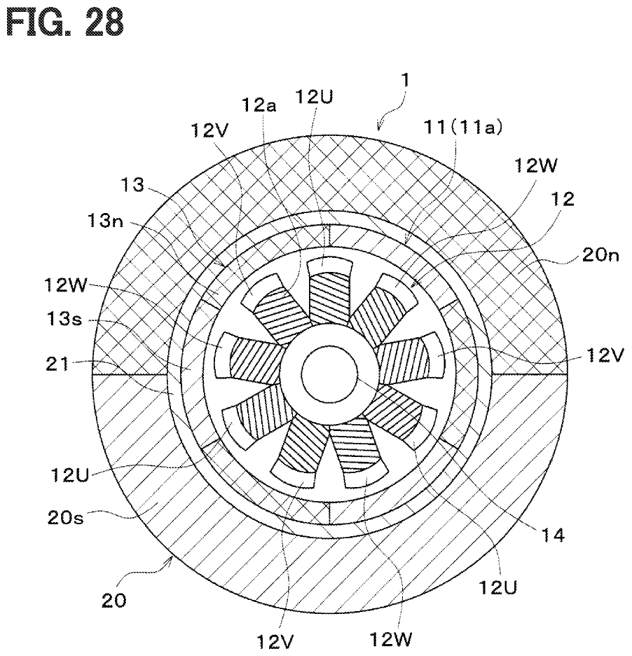

In the embodiment, the number of slots in each phase of the three-phase motors 11a is 2 and the number of pole pairs of the drive-side magnet 20 is 1 such that the sum of the induced voltages in each of the phases of the three-phase motors 11a becomes 0. In this embodiment, as illustrated in FIG. 28, the number of pole pairs of the drive-side magnet 20 differs from multiple of the number of slots in one phase. In other words, the number of pole pairs of the drive-side magnet 20 differs from the number found by integral multiple of the number of slots of one phase.

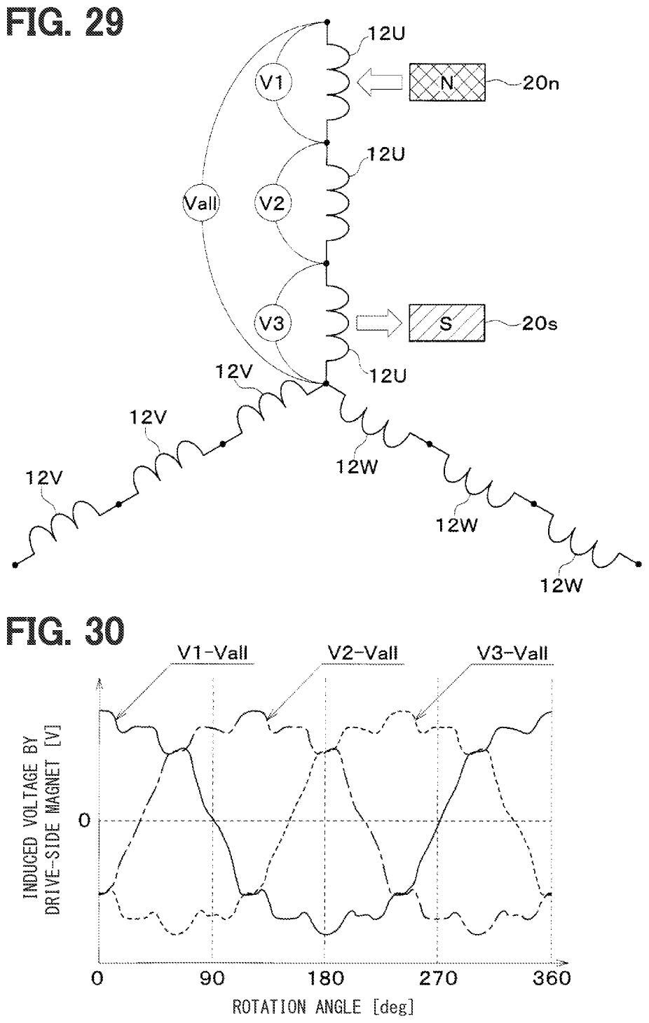

As illustrated in FIG. 28 and FIG. 29, the motor unit 11 is the three-phase motors 11a. The cylindrical rotor 13 is disposed outside in the radial direction of the stator 12.

The number of slots Ns of the stator 12 is 9. Accordingly, the phases of the U-phase, the V-phase, and the W-phase each have three slots. The nine slots of the stator 12 are disposed in the order from the U-phase slot 12U, the V-phase slot 12V, the W-phase slot 12W, the U-phase slot 12U, the V-phase slot 12V, the W-phase slot 12W, the U-phase slot 12U, the V-phase slot 12V, and the W-phase slot 12W in the circumferential direction.

The nine slots 12U, 12V, 12W, 12U, 12V, 12W, 12U, 12V, 12W of the stator 12 are equally disposed in the circumferential direction. The nine slots 12U, 12V, 12W, 12U, 12V, 12W, 12U, 12V, 12W of the stator 12 are disposed at every 40 degrees in the circumferential direction.

Accordingly, among the nine slots 12U, 12V, 12W, 12U, 12V, 12W, 12U, 12V, 12W of the stator 12, the three slots in the same phase are disposed at every 120 degrees in the circumferential direction.

The winding directions of the stator coils 12a of the stator 12 are in the mutually same direction in all slots.

The drive-side magnet 20 is disposed coaxially with the rotor 13 outside in the radial direction of the rotor 13. The number of poles Pin of the drive-side magnet 20 is 4. Accordingly, the number of pole pairs of the drive-side magnet 20 is 2. The N-poles 20n and the S-poles 20s of the drive-side magnet 20 are disposed alternatingly and equally in the circumferential direction. The N-poles 20n and the S-poles 20s of the drive-side magnet 20 are disposed at every 90 degrees in the circumferential direction.

In the configuration, when current flows through the stator coils 12a and the rotor 13 rotates, as illustrated in FIG. 30, in the three slots in each of the phases in the three-phase motors 11a, the phases of the induced voltages shift to one another by 120 degrees by the drive-side magnet 20, and therefore the sum of the induced voltages in each of the phases of the three-phase motors 11a becomes approximately 0. Similarly to the other two phases, the sum of the induced voltages becomes approximately 0.

Accordingly, in the slots in each phase, the induced voltages by the drive-side magnet 20 almost cancel one another, and therefore the rotational resistance in the motor unit 11 can be reduced.

In this embodiment, the winding directions of the stator coils 12a of the stator 12 are in the mutually same direction in all slots, and the number of pole pairs of the drive-side magnet 20 differs from the multiple of the number of slots in each of the phases.

Accordingly, in the slots in each phase, the induced voltages by the drive-side magnet 20 almost cancel one another, and therefore the rotational resistance in the motor unit 11 can be reduced.

### Fifteenth Embodiment

In the thirteenth embodiment, although the winding directions of the stator coils 12a of the stator 12 are in the mutually same direction in all slots, in this embodiment, the number of slots in which the stator coils 12a are right-handed and the number of slots in which the stator coils 12a are left-handed are the same. The number of pole pairs of the drive-side magnet 20 differs from the odd multiple of the half of the number of slots in a single phase.

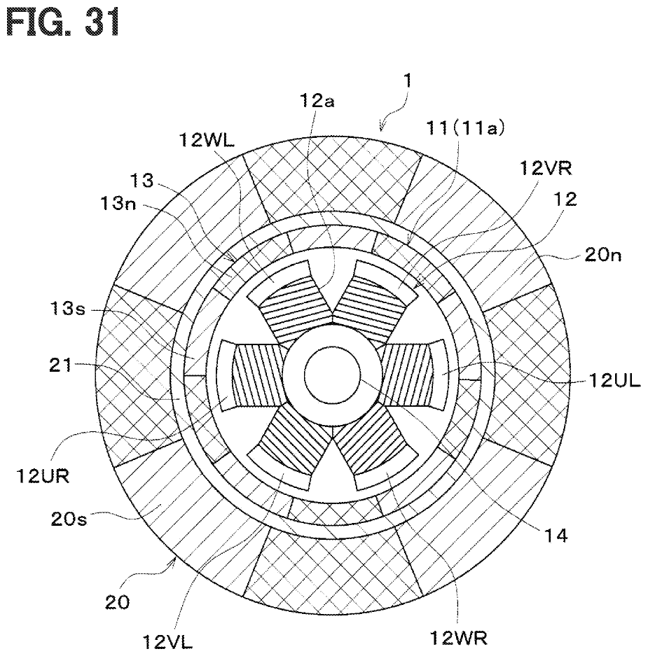

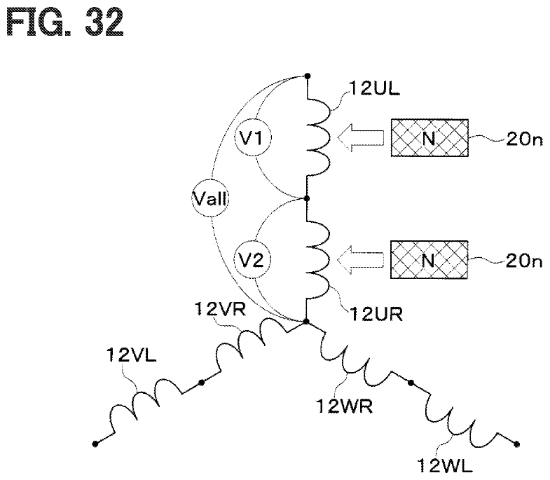

As illustrated in FIG. 31 and FIG. 32, the motor unit 11 of this embodiment is the three-phase motors 11a. The cylindrical rotor 13 is disposed outside in the radial direction of the stator 12.

The number of slots Ns of the stator 12 is 6. Accordingly, the stator 12 includes each three pieces of the right-handed slots and the left-handed slots. The phases of the U-phase, the V-phase, and the W-phase each have two slots. The six slots of the stator 12 are disposed in the order from a U-phase right-handed slot 12UR, a V-phase left-handed slot 12VL, a W-phase right-handed slot 12WR, a U-phase left-handed slot 12UL, a V-phase right-handed slot 12VR, and a W-phase left-handed slot 12WL.

The six slots 12UR, 12VL, 12WR, 12UL, 12VR, 12WL of the stator 12 are equally disposed in the circumferential direction. The six slots 12UR, 12VL, 12WR, 12UL, 12VR, 12WL of the stator 12 are disposed at every 60 degrees in the circumferential direction.

Accordingly, among the six slots 12UR, 12VL, 12WR, 12UL, 12VR, 12WL of the stator 12, a pair of the slots in the same phase are disposed at every 180 degrees in the circumferential direction. In other words, among the six slots 12UR, 12VL, 12WR, 12UL, 12VR, 12WL of the stator 12, the pair of slots in the same phase are disposed at positions facing one another.

Among the six slots 12UR, 12VL, 12WR, 12UL, 12VR, 12WL of the stator 12, the winding direction of the stator coils 12a in one slot among the pair of slots in the same phase is the right-handed and the winding direction of the stator coils 12a in the other slot is the left-handed. Accordingly, in the pairs of slots in the same phase, the number of right-handed stator coils 12a and the number of left-handed stator coils 12a are the same.

In the six slots 12UR, 12VL, 12WR, 12UL, 12VR, 12WL of the stator 12, the right-handed slots of the stator coils 12a and the left-handed slots of the stator coils 12a are alternately disposed.

Accordingly, the pair of slots opposed to one another among the six slots of the stator 12 have the winding directions of the stator coils 12a opposite to one another.

The drive-side magnet 20 is disposed coaxially with the rotor 13 outside in the radial direction of the rotor 13.

The number of poles Pin of the drive-side magnet 20 is 8. Accordingly, the number of pole pairs of the drive-side magnet 20 is 4. The N-poles 20n and the S-poles 20s of the drive-side magnet 20 are disposed alternatingly and equally in the circumferential direction. The N-poles 20n and the S-poles 20s of the drive-side magnet 20 are disposed at every 45 degrees in the circumferential direction.

In the two slots in each phase of the three-phase motors 11a, the positional relationships between the N-poles 40n and the S-poles 40s of the drive-side magnet 20 are mutually the same, but the winding directions of the stator coils 12a are opposite to one another, and therefore the magnetic flux of the drive-side magnet 20 becomes the opposite phase.

Therefore, similar to FIG. 27 described above, in the two slots in one phase of the three-phase motors 11a, the induced voltages by the drive-side magnet 20 become to have opposite phases and cancel one another, and therefore the sum of the induced voltages in one phase of the three-phase motors 11a becomes 0. Similarly to the other two phases, the sum of the induced voltages becomes 0.

Accordingly, in the slots in each phase, the induced voltages by the drive-side magnet 20 cancel one another, and therefore the rotational resistance in the motor unit 11 can be reduced.

In this embodiment, in the slots of the stator 12 in each of the phases, the number of stator coils 12a having the right-handed winding direction and the number of stator coils 12a having the left-handed winding direction are mutually the same, and the number of pole pairs of the drive-side magnet 20 differs from the odd multiple of the half of the number of slots in each of the phases.

Accordingly, in the slots in each phase, the induced voltages by the drive-side magnet 20 almost cancel one another, and therefore the rotational resistance in the motor unit 11 can be reduced.

### Sixteenth Embodiment

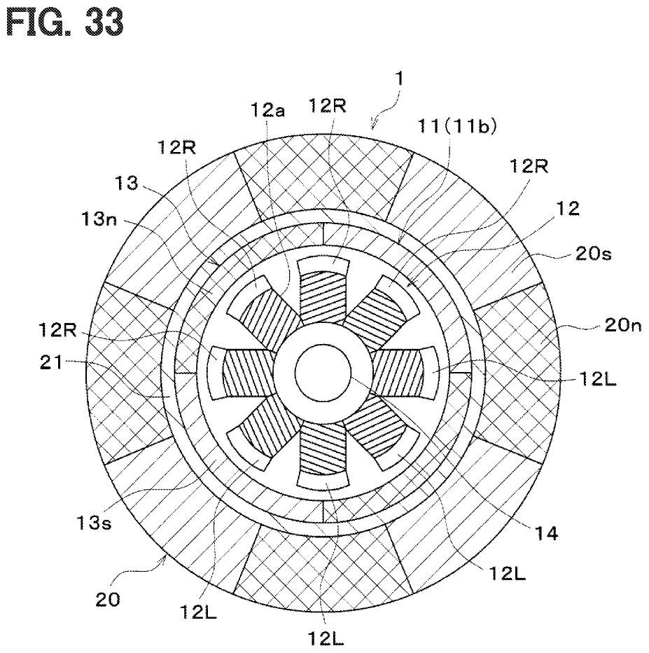

In the fifteenth embodiment, the motor unit 11 is the three-phase motors 11a, but in this embodiment, as illustrated in FIG. 33, the motor unit 11 is stepping motors 11b.

The cylindrical rotor 13 is disposed outside in the radial direction of the stator 12.

The number of slots Ns of the stator 12 is 8. The eight slots of the stator 12 are equally disposed in the circumferential direction. The six slots of the stator 12 are disposed at every 45 degrees in the circumferential direction.

Among the eight slots of the stator 12, the number of right-handed slots 12R of the stator coils 12a and the number of left-handed slots 12L of the stator coils 12a are the same. The number of right-handed slots 12R of the stator coils 12a is four, and the number of left-handed slots 12L of the stator coils 12a is also four.

Among the eight slots 12R, 12L of the stator 12, the four right-handed slots 12R of the stator coils 12a are continuously disposed in the circumferential direction, and the four left-handed slots 12L of the stator coils 12a are also continuously disposed in the circumferential direction.

Accordingly, the pair of slots opposed to one another among the eight slots 12R, 12L of the stator 12 having the winding directions of the stator coils 12a opposite to one another.

The drive-side magnet 20 is disposed coaxially with the rotor 13 outside in the radial direction of the rotor 13.

The number of poles Pin of the drive-side magnet 20 is 8. Accordingly, the number of pole pairs of the drive-side magnet 20 is 4. The N-poles 20n and the S-poles 20s of the drive-side magnet 20 are disposed alternatingly and equally in the circumferential direction. The N-poles 20n and the S-poles 20s of the drive-side magnet 20 are disposed at every 45 degrees in the circumferential direction.

In the pair of slots opposed to one another among the eight slots 12R, 12L of the stator 12, the positional relationships between the N-poles 40n and the S-poles 40s of the drive-side magnet 20 are mutually the same, but the winding directions of the stator coils 12a are opposite to one another, and therefore the magnetic flux of the drive-side magnet 20 becomes the opposite phase.

Therefore, similar to FIG. 27 described above, in the pair of slots opposed to one another, the induced voltages by the drive-side magnet 20 become to have opposite phases and cancel one another, and therefore the sum of the induced voltages in the pair of slots opposed to one another becomes 0.

Accordingly, in the pair of slots opposed to one another, the induced voltages by the drive-side magnet 20 cancel one another, and therefore the rotational resistance in the motor unit 11 can be reduced.

### Seventeenth Embodiment

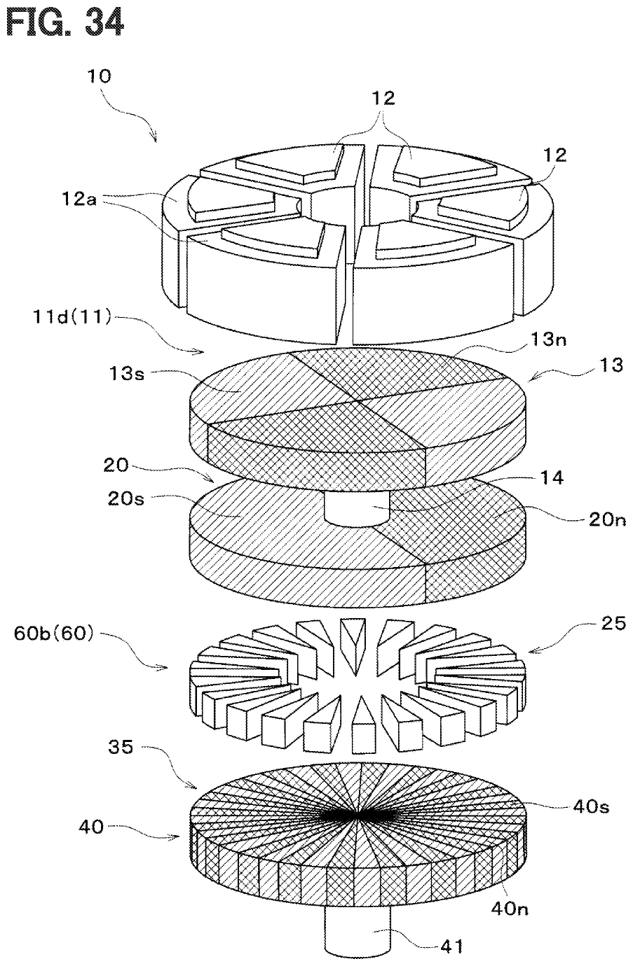

In the embodiments, while the rotor 13, the stator 12, and the drive-side magnet 20 are arranged in the radial direction of the rotor 13, in this embodiment, as illustrated in FIG. 34, the rotor 13, the stator 12, and the drive-side magnet 20 are arranged in the axial direction of the rotor 13. That is, in this embodiment, the motor unit 11 is axial gap motors 11d.

In the axial gap motor 11d, the arrangement direction of the stator 12 and the drive-side magnet 20 is same as the arrangement direction of the rotor 13 and the stator 12, and therefore the direction of the magnetic flux by the stator 12 and the drive-side magnet 20 is the same as the direction of the magnetic flux by the rotor 13 and the stator 12. Accordingly, induced voltages occur in the motor unit 11 by the drive-side magnet 20 and become rotational resistance.

Therefore, in this embodiment as well, the relationship between the number of slots Ns of the stator 12 and the number of poles Pin of the drive-side magnet 20 is configured similarly to the thirteenth and the seventeenth embodiments to cause the induced voltages by the drive-side magnet 20 to cancel one another, and thus the rotational resistance in the motor unit 11 can be reduced.

### Eighteenth Embodiment

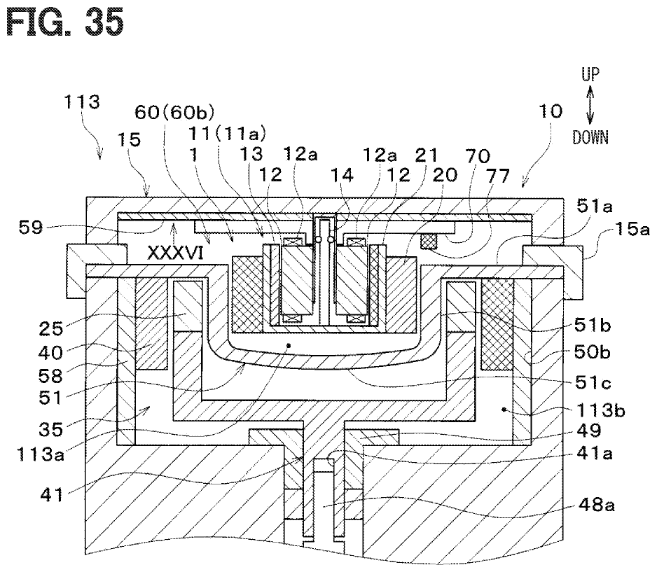

In this embodiment, as illustrated in FIG. 35, the circuit portion 70 includes an angular sensor 77 that detects the rotation angle.

The angular sensor 77 detects the magnetic flux of the drive-side magnet 20 to detect the rotation angle of the drive-side magnet 20, that is, the rotation angle of the shaft 14.

The detection signal of the angular sensor 77 is input to the circuit portion 70. Based on the detection signal of the angular sensor 77, the circuit portion 70 controls the drive current for driving the three-phase motors 11a.

The angular sensor 77 is fixed to the circuit portion 70 upward the drive-side magnet 20. The angular sensor 77 is disposed outside the radial direction with respect to the end portion inside in the radial direction of the drive-side magnet 20 and inside in the radial direction with respect to the center portion in the radial direction of the pole piece 25 in the radial direction of the rotor 13.

Since the angular sensor 77 is magnetized to the outer peripheral surface side of the drive-side magnet 20, the closer the position of the angular sensor 77 to the outer peripheral surface of the drive-side magnet 20 is, the more the magnetic flux of the drive-side magnet 20 can be properly detected.

The upper end of the drive-side magnet 20 is preferably positioned upward of the upper ends of the pole piece 25 and the stationary magnet 40. Thus, the upper end of the drive-side magnet 20 becomes close to the angular sensor 77 and the amount of magnetic flux of the drive-side magnet 20 adjacent to the angular sensor 77 increases, and therefore the magnetic flux of the drive-side magnet 20 can be properly detected.

The number of poles Pin of the drive-side magnet 20 is 2. Thus, when the drive-side magnet 20 rotates by one, the waveform of the magnetic flux detected by the angular sensor 77 is formed by one cycle, and thus the rotation angle of the shaft 14 can be accurately detected by the angular sensor 77.

A cylindrical pressure vessel 58 is disposed between the stationary magnet 40 and a body cylinder portion 50b of the body portion 50.

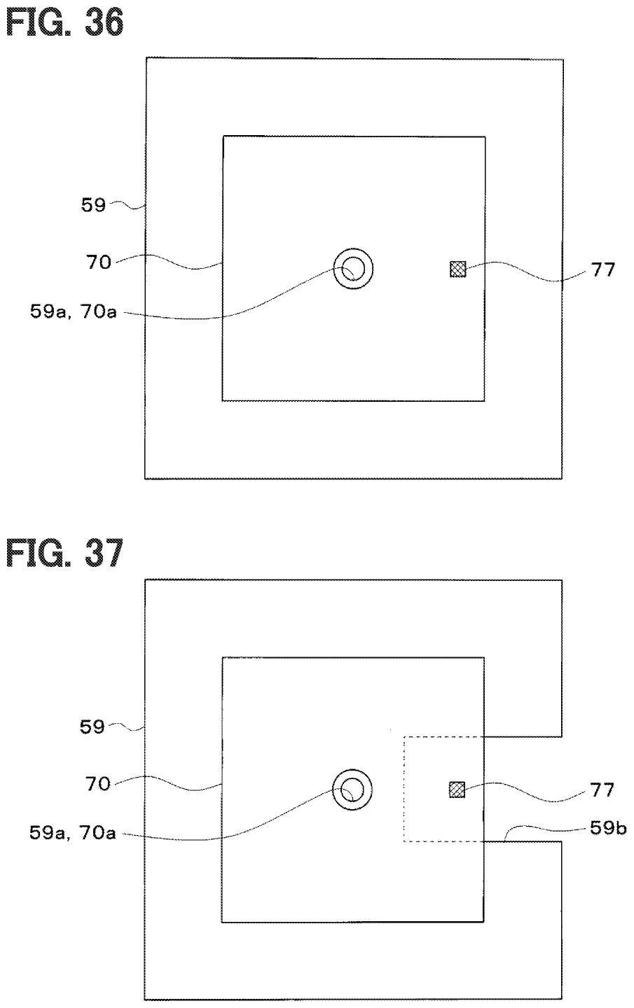

A reinforcing plate 59 is disposed between the circuit portion 70 and the motor case 15. The reinforcing plate 59 is a member that reinforces a shaft receiving part of the shaft 14. The reinforcing plate 59 is fixed to the circuit portion 70 and the motor case 15. As illustrated in FIG. 36, bearing holes 59a, 70a into which the shaft receiving part of the shaft 14 is inserted are formed in the reinforcing plate 59 and the circuit portion 70.

The pressure vessel 58 and the reinforcing plate 59 are made of a non-magnetic body. Thus, the pressure vessel 58 and the reinforcing plate 59 adversely affecting the detection of the magnetic flux by the angular sensor 77 can be suppressed.

### Nineteenth Embodiment

In the eighteenth embodiment, while the reinforcing plate 59 is made of the non-magnetic body, in this embodiment, the reinforcing plate 59 is made of the magnetic body. As illustrated in FIG. 37, by notching the portion at the proximity of the angular sensor 77 in the reinforcing plate 59, a cutout portion 59b is formed.

Accordingly, the reinforcing plate 59 adversely affecting the detection of the magnetic flux by the angular sensor 77 can be suppressed even when the reinforcing plate 59 is made of the magnetic body.

### Twentieth Embodiment

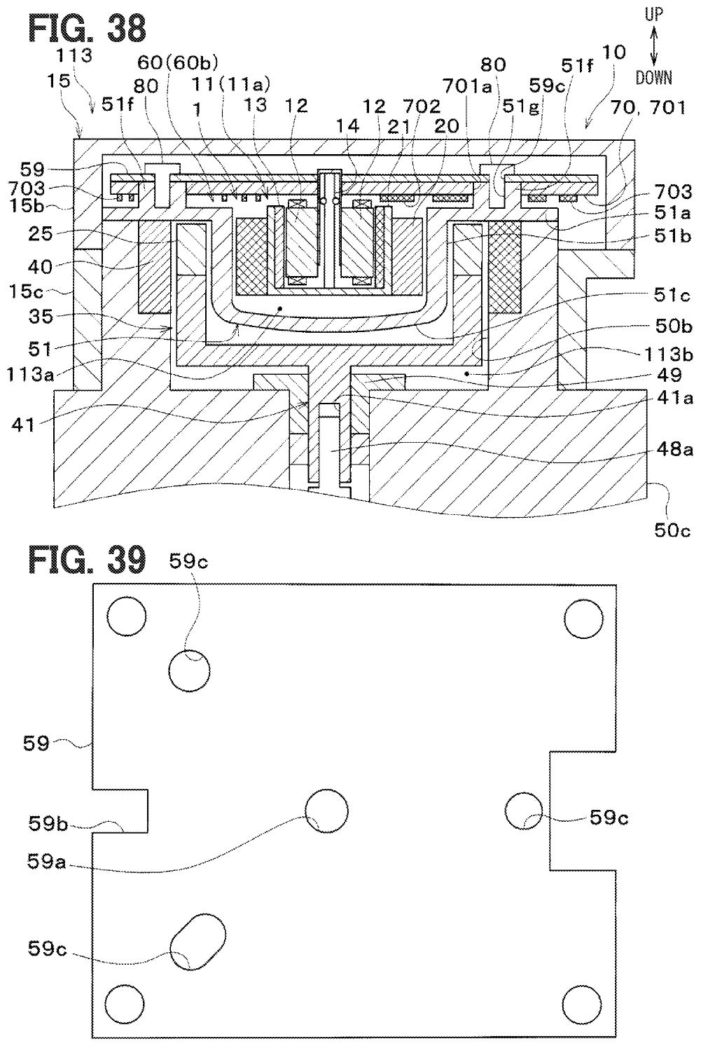

While the reinforcing plate 59 is fixed to the motor case 15 in the nineteenth embodiment, in this embodiment, as illustrated in FIG. 38, the reinforcing plate 59 is fixed to the sealing plate 51.

The reinforcing plate 59 is fastened and secured to the sealing plate 51 with bolts 80. Specifically, bolt fixing portions 51f are formed in the sealing top surface portion 51a of the sealing plate 51. The bolt fixing portion 51f has a cylindrical shape projecting to the reinforcing plate 59. Female thread holes 51g are formed in the bolt fixing portions 51f. The female thread hole 51g has a screw groove screwed with the bolt 80.

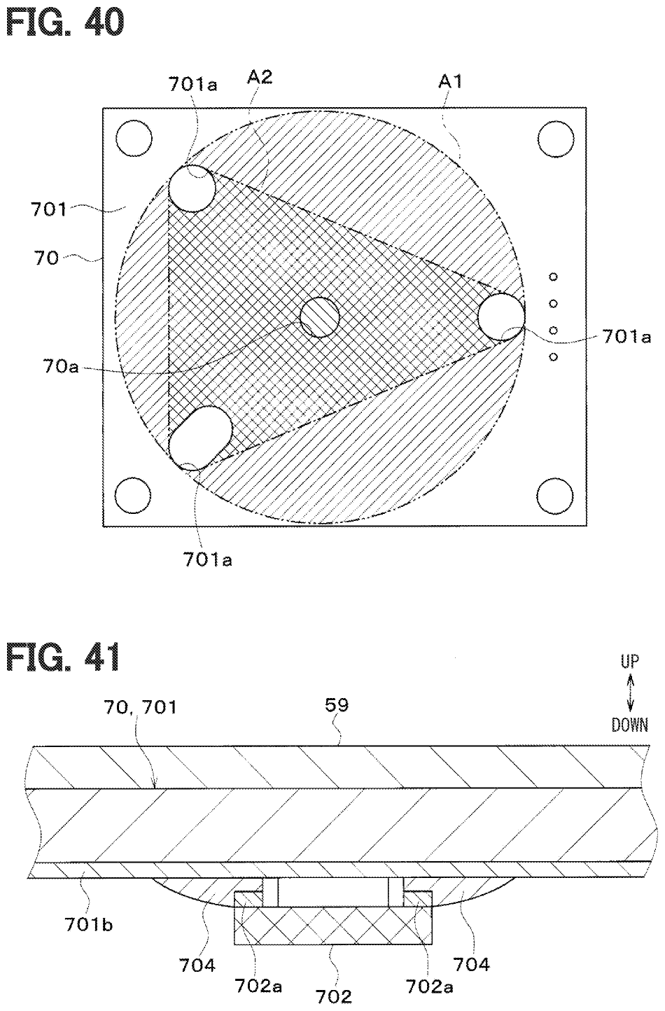

FIG. 39 is a plan view when the reinforcing plate 59 is viewed in the axis direction of the shaft 14. As illustrated in FIG. 39, the reinforcing plate 59 has bolt holes 59c through which the bolts 80 pass. FIG. 40 is a plan view when a circuit board 701 of the circuit portion 70 is viewed in the axis direction of the shaft 14. As illustrated in FIG. 40, the circuit board 701 has through-holes 701a through which the bolt fixing portions 51f pass.

A large number of the bolt fixing portions 51f, the bolt holes 59c, and the through-holes 701a are formed. In this example, three pieces of the bolt fixing portions 51f, the bolt holes 59c, and the through-holes 701a are each formed.

As illustrated in FIG. 38, the end surfaces of the bolt fixing portions 51f contact the reinforcing plate 59. The end surfaces of the bolt fixing portions 51f contact the reinforcing plate 59. The circuit board 701 is fixed to the reinforcing plate 59. For example, the circuit board 701 is a glass epoxy substrate. The glass epoxy substrate is a base material formed by impregnating stacked clothes made of glass fiber with epoxy resin.

The body portion 50, the sealing plate 51, and the reinforcing plate 59 are made of metal as a conductor and a magnetic body (such as iron-based metal and stainless steel). Accordingly, the sealing plate 51 and the reinforcing plate 59 are electrically connected to the ground (GND) with the body portion 50.

The planar shapes of the circuit board 701 and the reinforcing plate 59 are mutually the same and are rectangular shapes larger than the body cylinder portion 50b in the example. The portion lower than the body cylinder portion 50b in the body portion 50 is a polygonal body column 50c having an outer shape having a prismatic shape.

The motor case 15 includes an upper case 15b and a lower case 15c. The upper case 15b and the lower case 15c are made of a conductive material (such as resin mixed with iron powder).

The upper case 15b is formed in a square tube shape with a lid. The lower case 15c has an upper portion (the portion on the upper case 15b side) having a square tube shape and the lower portion (the portion on the polygonal body column 50c side) having a cylindrical shape.

The motor case 15 (the upper case 15b in this example) is fitted to the body portion 50 so as to cover the sealing plate 51 and the reinforcing plate 59 from outside in the radial direction. Thus, the motor case 15 covers a gap between the sealing plate 51 and the reinforcing plate 59.

The circuit portion 70 includes a plurality of circuit elements. A part of circuit elements among the plurality of circuit elements are circuit elements to generate radiation noise. In this example, the circuit element that generates radiation noise is an FET microcomputer 702. The FET microcomputer 702 converts DC power of a battery into AC power by switching and outputs the AC power. Examples of the circuit element that generates the radiation noise include an electronic component including a coil and an IC chip, in addition to the FET microcomputer 702.

The FET microcomputer 702 and the other circuit elements 703 are bonded to the circuit board 701 by soldering. When viewed in the axis direction of the shaft 14, the FET microcomputer 702 is disposed at a position overlapping with the reinforcing plate 59 and the sealing plate 51.

The FET microcomputer 702 is a Quad Flat Non-leaded (QFN) element. The QFN element is an element without a lead. Accordingly, as illustrated in FIG. 41, terminals 702a of the FET microcomputer 702 are not inserted into the circuit board 701 but are bonded with a solder 704 sandwiched between a copper foil pattern 701b of the circuit board 701 and the terminals 702a.

The switching of the FET microcomputer 702 causes the radiation noise, but the sealing plate 51, the reinforcing plate 59, and the motor case 15 can shut off the radiation noise from the FET microcomputer 702.

By the sealing plate 51 and the reinforcing plate 59 being electrically connected to the ground (GND) with the body portion 50, a shut-off effect of the radiation noise can be enhanced.

Since the body portion 50, the sealing plate 51, and the reinforcing plate 59 are made of the magnetic bodies, the shut-off effect of a low frequency component in the radiation noise can be enhanced.

The circuit board 701 is fixed to the reinforcing plate 59, the reinforcing plate 59 is fixed to the sealing plate 51, and the sealing plate 51 is fixed to the body portion 50. That is, the circuit board 701 is fixed to the body portion 50 having high strength via the reinforcing plate 59 and the sealing plate 51.

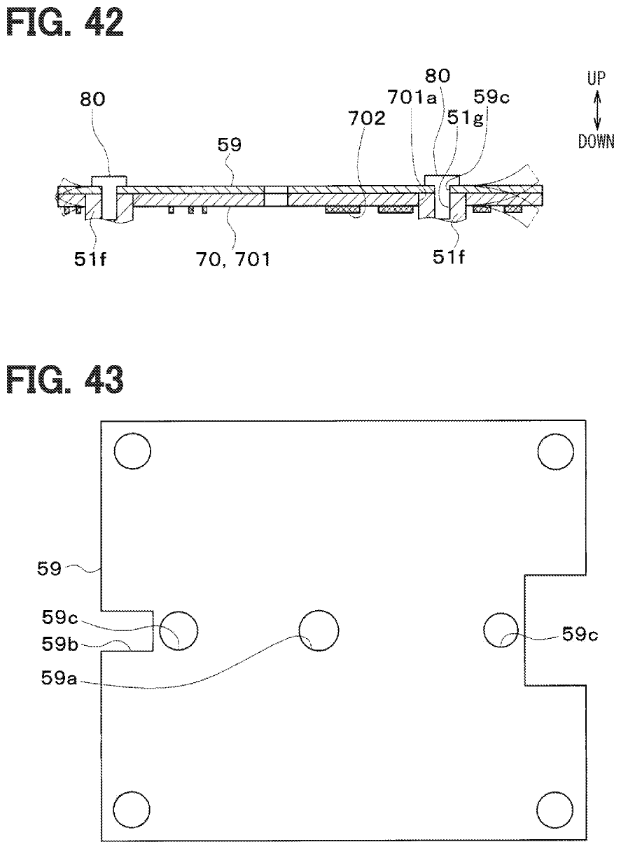

Thus, the bolt fixing portions 51f as fixing portions between the circuit board 701 and the reinforcing plate 59 serve as fulcrums, and therefore the circuit board 701 deforms as illustrated in FIG. 42. That is, as indicated by the two-dot chain lines in FIG. 42, although the circuit board 701 deforms outside the bolt fixing portion 51f, the deformation of the circuit board 701 is suppressed inside the bolt fixing portion 51f. Therefore, stress at the soldered part on the circuit board 701 is reduced.

When viewed in the axis direction of the shaft 14, the FET microcomputer 702 is disposed on the shaft 14 side with respect to an imaginary circumscribed circle Cl of a through-hole 701a (in other words, a portion where the circuit board 701 and the reinforcing plate 59 are fixed). Specifically, the FET microcomputer 702 is disposed in a hatched first range A1 in FIG. 40. Thus, the stress acting on the soldering portion of the circuit board 701 with the FET microcomputer 702 (namely, the solder 704) is effectively reduced.

More preferably, when viewed in the axis direction of the shaft 14, the FET microcomputer 702 is disposed between the through-holes 701a. Specifically, the FET microcomputer 702 is disposed in a hatched second range A2 in FIG. 40. Thus, the stress acting on the soldering portion of the circuit board 701 with the FET microcomputer 702 is further effectively reduced.

In this embodiment, the FET microcomputer 702 is disposed at the position overlapping with the sealing plate 51 and the drive-side magnet 20 in the axial direction in the circuit board 701, and the sealing plate 51 is made of a conductor. Thus, the radiation noise from the FET microcomputer 702 can be shut off by the sealing plate 51 in the axial direction of the drive-side magnet 20.

In this embodiment, the reinforcing plate 59 is made of the conductor and the FET microcomputer 702 is disposed at the position overlapping with the reinforcing plate 59 in the axial direction of the drive-side magnet 20. Thus, the radiation noise from the FET microcomputer 702 can be shut off by the reinforcing plate 59 in the axial direction of the drive-side magnet 20.

In this embodiment, the FET microcomputer 702 is disposed so as to face the sealing plate 51 side with respect to the circuit board 701. The motor case 15 is made of a conductor and covers the gap between the sealing plate 51 and the circuit board 701 from outside in the radial direction of the drive-side magnet 20. Thus, the radiation noise from the FET microcomputer 702 can be shut off by the motor case 15 in the radial direction of the drive-side magnet 20.

In this embodiment, the body portion 50 is made of a conductor, the sealing plate 51 is fixed to the body portion 50, and the bolt fixing portions 51f of the sealing plate 51 electrically connect the sealing plate 51 and the reinforcing plate 59. Thus, by the sealing plate 51 and the reinforcing plate 59 being electrically connected to the ground (GND) with the body portion 50, the shut-off effect of the radiation noise can be enhanced.

In this embodiment, the circuit board 701 is fixed to the reinforcing plate 59 and the sealing plate 51 includes the fixing portions 51f with which the reinforcing plate 59 is fixed. Accordingly, since the deformation of the circuit board 701 is suppressed, the stress at the soldered part on the circuit board 701 can be reduced.

In this embodiment, at least three of the fixing portions 51f are disposed and the FET microcomputer 702 is disposed in the first range A1 on the circuit board 701. The first range A1 is a range inside the imaginary circumscribed circle circumscribing all of the fixing portions 51f. Thus, the stress acting on the soldering portion of the circuit board 701 with the FET microcomputer 702 (namely, the solder 704) is effectively reduced.

### Twenty-First Embodiment

In the twentieth embodiment, the three bolt fixing portions 51f are formed, but in this embodiment, the two bolt fixing portions 51f are formed. The bolt fixing portions 51f are formed at intervals of 180 degrees in the circumferential direction of the shaft 14.

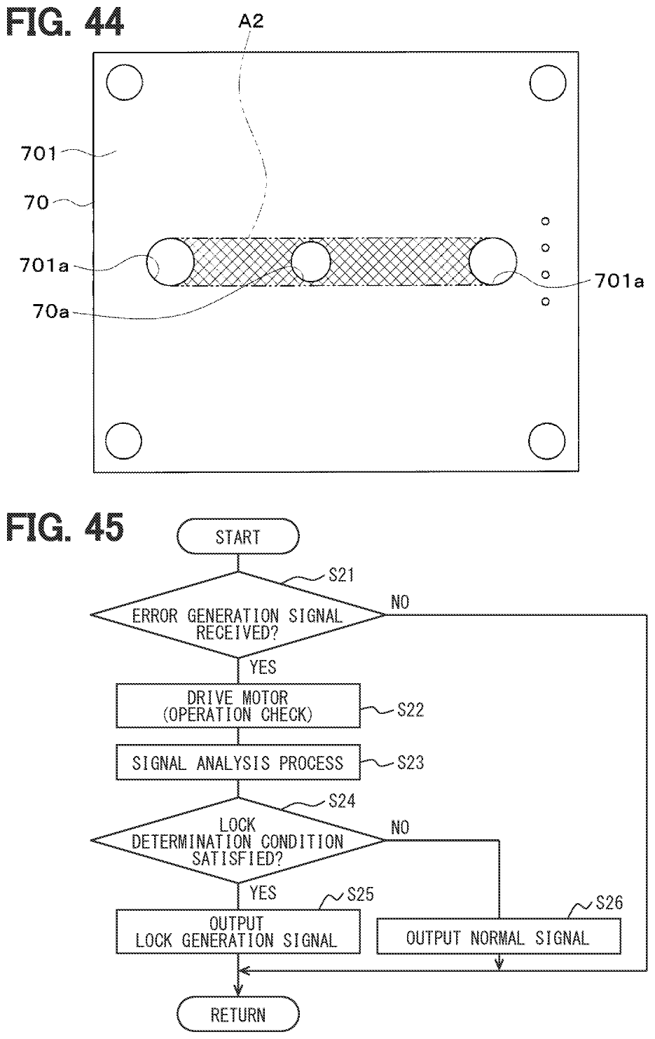

Accordingly, as illustrated in FIG. 43, the reinforcing plate 59 has two bolt holes 59c through which the bolts 80 pass, and as illustrated in FIG. 44, the circuit board 701 has two through-holes 701a through which the bolt fixing portions 51f pass.

When viewed in the axis direction of the shaft 14, the FET microcomputer 702 is disposed between the through-holes 701a. Specifically, the FET microcomputer 702 is disposed in the hatched second range A2 in FIG. 44. Thus, the stress acting on the soldering portion of the circuit board 701 with the FET microcomputer 702 is effectively suppressed.

In this embodiment, the two fixing portions 51f are disposed, and the FET microcomputer 702 is disposed in the second range A2 on the circuit board 701. The second range A2 is the range A2 between the fixing portions 51f. Thus, the stress acting on the soldering portion of the circuit board 701 with the FET microcomputer 702 is effectively suppressed.

### Twenty-Second Embodiment

As in the first embodiment and the like, when the stator 12 and the rotor 13 of the motor unit 11 are disposed inside the drive-side magnet 20, the magnetic flux of the motor unit 11 interferes with the magnetic flux of the drive-side magnet 20 and the flow of the magnetic flux of the magnetic gear 60b possibly becomes poor.

In consideration of the point, this embodiment includes a configuration to reduce the magnetic interference between the magnetic flux of the drive-side magnet 20 and the magnetic flux of the motor unit 11.

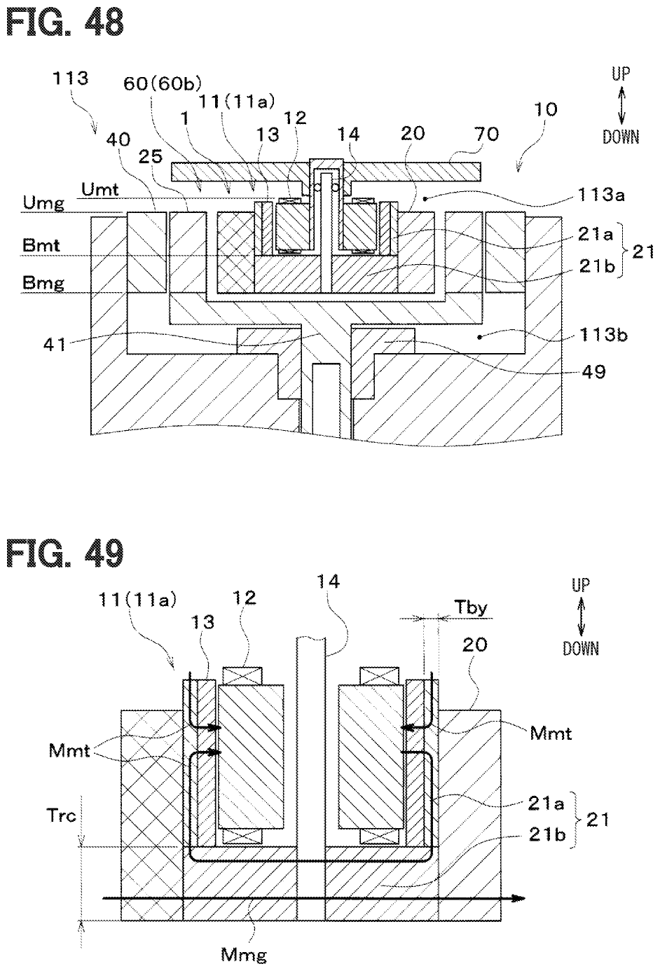

As illustrated in FIG. 48, the interposition member 21 includes a motor unit back yoke 21a and a rotor cup 21b. The motor unit back yoke 21a has a cylindrical shape and is disposed coaxially with the rotor 13 and the drive-side magnet 20 between the rotor 13 and the drive-side magnet 20. The rotor cup 21b covers the motor unit back yoke 21a from one end side in the axial direction of the drive-side magnet 20 (the lower side in FIG. 48). The motor unit back yoke 21a and the rotor cup 21b are made of magnetic bodies.

For convenience of illustration, FIG. 48 omits the illustration of the motor case 15, the sealing plate 51, the back yoke 56, and the like.

In the axial direction of the drive-side magnet 20, that is, the vertical direction of FIG. 48, a lower end position Bmg of the drive-side magnet 20, the pole piece 25, and the stationary magnet 40 is downward of a lower end position Bmt of the stator 12, the rotor 13, and the motor unit back yoke 21a.

In view of this, as illustrated in FIG. 49, since a magnetic flux Mmg of the drive-side magnet flows so as to avoid a magnetic flux Mmt of the motor unit 11 to the lower side, the magnetic interference is reduced and performance can be improved.

In the axial direction of the drive-side magnet 20, that is, the vertical direction of FIG. 48, an upper end position Umg of the drive-side magnet 20, the pole piece 25, and the stationary magnet 40 is downward of an upper end position Umt of the stator 12, the rotor 13, and the motor unit back yoke 21a.

In view of this, as illustrated in FIG. 49, since the magnetic flux Mmg of the drive-side magnet flows so as to avoid the magnetic flux Mmt of the motor unit 11 to the lower side further, the magnetic interference is further reduced and performance can be further improved.

In other words, in the axial direction of the drive-side magnet 20, that is, the vertical direction of FIG. 48, since the center position of the drive-side magnet 20, the pole piece 25, and the stationary magnet 40 is downward of a center position Umt of the stator 12, the rotor 13, and the motor unit back yoke 21a, the magnetic flux Mmg of the drive-side magnet flows so as to avoid the magnetic flux Mmt of the motor unit 11 to downward further and the magnetic interference can be reduced.

A thickness Trc of the rotor cup 21b in the axial direction of the drive-side magnet 20, that is, the vertical direction of FIG. 49, is larger than a thickness Tby of the motor unit back yoke 21a in the radial direction of the drive-side magnet 20, that is, the lateral direction of FIG. 49.

In view of this, as illustrated in FIG. 49, since the magnetic flux Mmg of the drive-side magnet easily flows so as to avoid the magnetic flux Mmt of the motor unit 11 to the rotor cup side, the magnetic interference is reduced and performance can be improved.

This disclosure can be variously modified as follows within the scope not departing from the gist of this disclosure and is not limited to the above-described embodiments.

In the embodiments, a corner portion as a boundary between the sealing cylinder portion 51b and the sealing bottom surface portion 51c has a shape rounded at a predetermined curvature radius, but the corner portion as the boundary between the sealing cylinder portion 51b and the sealing bottom surface portion 51c may have a right angle.

In the embodiments, the axial length Lp of the pole piece 25 is shorter than the axial length L2 of the stationary magnet 40 and the axial length L2 of the stationary magnet 40 is longer than the axial length L1 of the drive-side magnet 20, but the axial length Lp of the pole piece 25 may be the same as the axial length L2 of the stationary magnet 40. The axial length L1 of the drive-side magnet 20 may be the same as the axial length L2 of the stationary magnet 40.

In the embodiments, the sealing plate 51 is integrally molded, but in the sealing plate 51, when at least the sealing cylinder portion 51b is formed of a single member, the sealing cylinder portion 51b can be thinned while the pressure resistance is ensured, thus the magnetic reluctance can be reduced.

In the embodiments, the stationary magnet 40 is fixed to the inner peripheral surface of the body cylinder portion 50b via the back yoke 56, but the stationary magnet 40 may be directly fixed to the inner peripheral surface of the body cylinder portion 50b.

In the embodiments, while the vertical arrangement is performed on the first expansion valve 113 in the vehicle, transverse arrangement may be performed on the first expansion valve 113 in the vehicle. The “transverse arrangement” is arrangement in which the axial direction of the valve element 48 is approximately parallel to the vehicle front-rear lateral direction. The first expansion valve 113 may be disposed upside down compared with the first embodiment.

In the embodiments, the axis alignment portion 15a is integrated with the motor case 15, but the axis alignment portion may be integrated with the housing 50 and the sealing plate 51 and the motor case may be fixed with a screw clamp or the like.

In the above-described embodiments, in accordance with the flowchart depicted in FIG. 12, at the start of the vehicle, at the start of the vehicle air conditioner, and during the air conditioning operation, whether the lock determination condition is met is determined to always monitor the lock of the pole piece 25 or the like. w

As illustrated in FIG. 45, first, in Step S21, whether an error generation signal has been received is determined. When the error generation signal is received, the process proceeds to Step S22. When the error signal is not received, the lock determination control depicted in FIG. 45 ends directly.

Here, the error signal is a control signal output from the control device disposed outside and is output when the operation of the power transmission device 1 is considered to have an error. For example, when a refrigerant temperature and refrigerant pressure in the refrigeration cycle of the vehicle air conditioner apparently show abnormal values, the air conditioning control device of the vehicle air conditioner outputs the error signal.

In Step S22, to check the operation of the power transmission device 1, the motor unit 11 is driven. At this time, similar to Step S2 and the like, the rotor 13 is operated at a constant rotation. In Step S23, the signal analysis process is performed on an output signal (such as input current) output by driving the motor unit 11 in Step S22. The content of the signal analysis process is similar to Step S3 and the like, and the frequency analysis is performed on the output signal.

When the process transitions to Step S24, whether the lock determination condition is met is determined. When the lock determination condition is met, it is determined that the pole piece 25 or the like is firmly fixed in the lock state, and the lock generation signal is output in Step S25.

When the lock determination condition is not met, in Step S26, the drive-side magnet 20 and the pole piece 25 are determined to be rotatable in the standard state and a normal signal is output. The normal signal indicates that the drive-side magnet 20 and the pole piece 25 integrally rotate in the standard state.

The lock determination control according to the modification depicted in FIG. 45 drives the motor unit 11, performs frequency analysis, and performs determination regarding the lock determination condition in response to reception of the error signal from outside. Thus, the power transmission device 1 according to the modification can determine whether the lock occurs in the pole piece 25 or the like at adequate timing. Compared with the configuration that always performs monitoring, a processing load on the lock determiner 71 can be reduced.

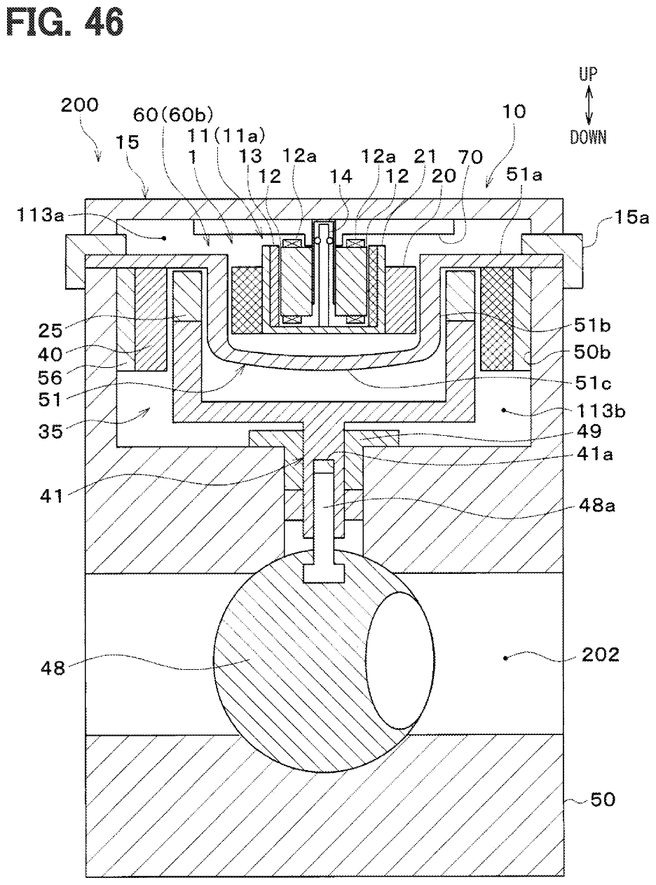

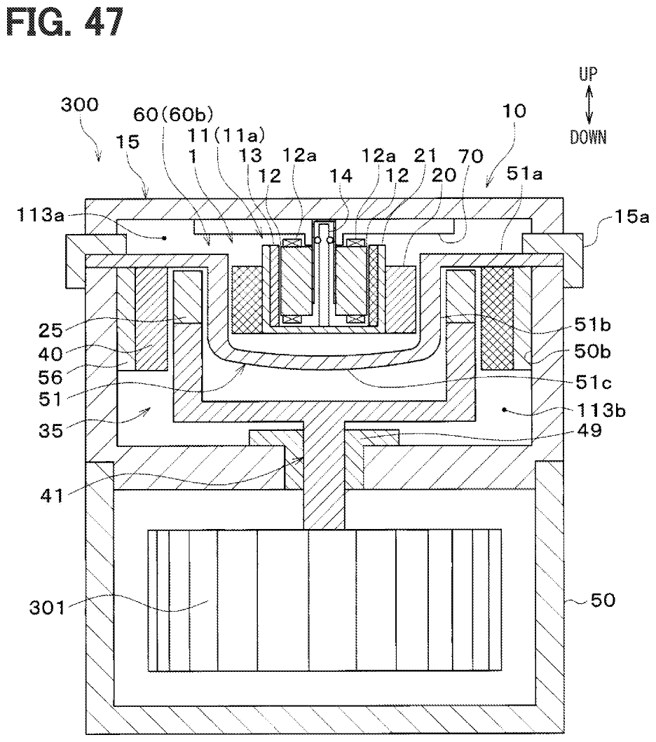

In the embodiments, while the power transmission device 1 is applied to the expansion valve of the vapor compression refrigeration cycle, as illustrated in FIG. 46 and FIG. 47, the power transmission device 1 is also applicable to a rotary machine, such as a flow rate regulating valve 200 and a compact pump 300.

The flow rate regulating valve 200 rotates a valve element 201 by driving power transmitted by the power transmission device 1 at a predetermined angle and regulates a degree of opening of a flow passage 202 to regulate a flow rate of a fluid in the flow passage 202.

The compact pump 300 continuously rotates an impeller 301 by driving power transmitted by the power transmission device 1 to suction and discharge the fluid.

In the twentieth embodiment, while the reinforcing plate 59 is fastened and secured to the sealing plate 51 with the bolts 80, the reinforcing plate 59 may be fixed to the sealing plate 51 by rivet, caulking, welding, or the like.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A power transmission device comprising:
a drive-side magnet that includes a plurality of poles and rotates;
a housing that houses the drive-side magnet;
a stationary magnet that has a number of poles larger than a number of poles of the drive-side magnet and is fixed to the housing;
a pole piece that includes a plurality of magnetic body portions and rotates by modulating a magnetic flux between the drive-side magnet and the stationary magnet; and
a sealing member that partitions an inside of the housing into a driving side space where the drive-side magnet is disposed and a driven side space where the stationary magnet and the pole piece are disposed, the sealing member sealing fluid between the driving side space and the driven side space, wherein
the pole piece and the stationary magnet have a cylindrical shape and are disposed coaxially with and radially outer side of the drive-side magnet, and
the sealing member includes a sealing cylinder portion positioned radially outer side of the drive-side magnet, and a sealing bottom surface portion covering the sealing cylinder portion from the driving side space.

2. The power transmission device according to claim 1, wherein
a number Npp of the magnetic body portions has a relationship of:
Npp=(Pin+Pf)/2
with the number of poles Pin of the drive-side magnet and the number of poles Pf of the stationary magnet.

3. The power transmission device according to claim 1, wherein
the housing includes a cylindrical housing cylinder portion that surrounds the drive-side magnet, the stationary magnet, and the pole piece from a radially outer side,
the power transmission device further includes a back yoke made of a magnetic body in a cylindrical shape and fixed on an inner peripheral surface of the housing cylinder portion, and
the stationary magnet is fixed on an inner peripheral surface of the back yoke.

4. The power transmission device according to claim 1, wherein
the housing includes a cylindrical housing cylinder portion that surrounds the drive-side magnet, the stationary magnet, and the pole piece a radially outer side, and
the stationary magnet is fixed on an inner peripheral surface of the housing cylinder portion.

5. The power transmission device according to claim 3, wherein
the housing cylinder portion is made of a magnetic body.

6. The power transmission device according to claim 1, comprising a bearing member that rotatably supports the pole piece with respect to the housing, wherein
the pole piece is positioned away from the bearing member with respect to an imaginary line connecting an end portion of the drive-side magnet away from the bearing member and an end portion of the stationary magnet away from the bearing member, in an axial direction of the drive-side magnet.

7. The power transmission device according to claim 1, wherein
the pole piece is shorter than the drive-side magnet and the stationary magnet in an axial direction of the drive-side magnet.

8. The power transmission device according to claim 1, wherein
the stationary magnet is longer than the drive-side magnet in an axial direction of the drive-side magnet.

9. The power transmission device according to claim 1, wherein
the drive-side magnet is longer than the pole piece and shorter than the stationary magnet in an axial direction of the drive-side magnet.

10. The power transmission device according to claim 1, wherein
the housing includes:
a cylindrical housing cylinder portion that surrounds the drive-side magnet, the stationary magnet, and the pole piece from a radially outer side; and
an axis alignment portion fixed on the housing cylinder portion for axially aligning the drive-side magnet with the pole piece.

11. The power transmission device according to claim 1, wherein
the sealing cylinder portion is made of a single non-magnetic body member.

12. The power transmission device according to claim 1, wherein
the sealing member includes a sealing top surface portion that extends outward in a radial direction from an end portion of the sealing cylinder portion away from the sealing bottom surface portion, and
the sealing top surface portion, the sealing cylinder portion, and the sealing bottom surface portion are made of a single non-magnetic body member.

13. The power transmission device according to claim 1, comprising
an output shaft that rotates integrally and coaxially with the pole piece, wherein
the sealing bottom surface portion includes a driven side shaft receiving portion that rotatably supports the output shaft.

14. The power transmission device according to claim 1, comprising an input shaft that rotates integrally and coaxially with the drive-side magnet, wherein
the sealing bottom surface portion includes a driving side shaft receiving portion that rotatably supports the input shaft.

15. The power transmission device according to claim 1, wherein
the driven side space is a space where a fluorocarbon refrigerant is present.

16. The power transmission device according to claim 1, wherein
the pole piece drives a valve element of an expansion valve that causes a refrigerant of a vapor compression refrigeration cycle to decompress and expand, and
the driven side space is a space where the refrigerant is present.

17. The power transmission device according to claim 1, wherein
the pole piece drives a valve element of a flow rate regulating valve that regulates a flow rate of a fluid, and
the driven side space is a space where the fluid is present.

18. The power transmission device according to claim 1, wherein
the pole piece drives an impeller of a pump that causes a fluid to flow, and
the driven side space is a space where the fluid is present.

19. The power transmission device according to claim 1, comprising:
a motor unit that outputs driving power to rotate the drive-side magnet by electromagnetic force; and
a lock determination unit that determines whether lock occurs in the pole piece using a variation in a rotational load regarding an operation of the drive-side magnet.

20. The power transmission device according to claim 19, wherein
a number of poles of the motor unit differs from the number of poles of the drive-side magnet.

21. The power transmission device according to claim 19, wherein
½ of the number of poles of the motor unit differs from a least common multiple of ½ of the number of poles in the drive-side magnet and ½ of the number of poles in the stationary magnet, and
a least common multiple of the number of poles of the motor unit and a number of slots in the motor unit differs from a least common multiple of ½ of the number of poles in the drive-side magnet and ½ of the number of poles in the stationary magnet.

22. The power transmission device according to claim 19, wherein
the lock determination unit performs frequency analysis on an input current to the motor unit, and when the input current in a predetermined specific frequency exceeds a reference value, lock is determined to occur in the pole piece.

23. The power transmission device according to claim 19, wherein
the motor unit is a three-phase motor, and
the lock determination unit performs frequency analysis on a drive current of the three-phase motor, and when the drive current in a predetermined specific frequency exceeds a reference value, lock is determined to occur in the pole piece.

24. The power transmission device according to claim 19, wherein
the motor unit is a DC motor including a commutator and a brush, and
the lock determination unit performs frequency analysis on a drive current of the DC motor, and when the drive current in a predetermined specific frequency exceeds a reference value, lock is determined to occur in the pole piece.

25. The power transmission device according to claim 19, wherein
the motor unit is a three-phase motor,
the power transmission device includes a three-phase inverter circuit unit for identifying a duty ratio from a relationship between a predetermined triangular-wave and a determination voltage determined in conjunction with the variation in the rotational load, the duty ratio being a ratio between on time and off time in the three-phase motor, and
the lock determination unit performs frequency analysis on the determination voltage that changes in conjunction with the variation in the rotational load, and when the determination voltage in a predetermined specific frequency exceeds a reference value, lock is determined to occur in the pole piece.

26. The power transmission device according to claim 19, wherein
the motor unit is a three-phase motor, and
the lock determination unit performs frequency analysis on a current in any one phase in the three-phase motor, and when the current in the one phase in a predetermined specific frequency exceeds a reference value, lock is determined to occur in the pole piece.

27. The power transmission device according to claim 19, wherein
the motor unit is a three-phase motor, and
the lock determination unit performs frequency analysis on a line voltage regarding any two phases of the three-phase motor, and when the line voltage in a predetermined specific frequency exceeds a reference value, lock is determined to occur in the pole piece.

28. The power transmission device according to claim 19, comprising
an acceleration sensor that detects an acceleration caused by a vibration in association with the variation in the rotational load, wherein
the lock determination unit performs frequency analysis on the acceleration detected by the acceleration sensor, and when a change in the acceleration in a predetermined specific frequency exceeds a reference value, lock is determined to occur in the pole piece.

29. The power transmission device according to claim 1, comprising
a motor unit that includes a stator and a rotor, the stator including a slot around which a coil is wound, the rotor including a magnet to rotate, the motor unit driving the drive-side magnet by the rotor, wherein
a plurality of slots is disposed in each phase, and
the drive-side magnet is configured such that induced voltages occurred in the coil by the drive-side magnet cancel one another in each phase.

30. The power transmission device according to claim 1, comprising
a motor unit that includes a stator and a rotor, the stator including a slot around which a coil is wound, the rotor including a magnet to rotate, the motor unit driving the drive-side magnet by the rotor, wherein
a plurality of slots is disposed in each phase and equally disposed in a circumferential direction of the rotor,
winding directions of the coil are a same direction in all of the slots,
the drive-side magnet includes a plurality of poles equally disposed in the circumferential direction of the rotor, and
a number of pole pairs of the drive-side magnet differs from a multiple of a number of slots in each phase.

31. The power transmission device according to claim 1, comprising
a motor unit that includes a stator and a rotor, the stator including a slot around which a coil is wound, the rotor including a magnet to rotate, the motor unit driving the drive-side magnet by the rotor, wherein
a plurality of slots is disposed in each phase and equally disposed in a circumferential direction of the rotor,
a number of slots having a right-handed winding direction of the coil is a same as a number of slots having a left-handed winding direction of the coil in each phase,
a plurality of pole of the drive-side magnet are equally disposed in a circumferential direction of the rotor, and
a number of pole pairs of the drive-side magnet differs from an odd multiple of a half of a number of slots in each phase.

32. The power transmission device according to claim 29, wherein
the rotor, the stator, and the drive-side magnet are disposed to be arranged in a radial direction of the rotor.

33. The power transmission device according to claim 29, wherein
the rotor, the stator, and the drive-side magnet are disposed to be arranged in an axial direction of the rotor.

34. The power transmission device according to claim 1, comprising
a motor unit that includes a stator and a rotor, the stator including a coil, the rotor including a magnet to rotate, the motor unit driving the drive-side magnet by the rotor, wherein
the drive-side magnet has a cylindrical shape, and
the stator and the rotor are disposed inside the drive-side magnet.

35. The power transmission device according to claim 34, comprising
an interposition member made of a magnetic body and disposed between the rotor and the drive-side magnet.

36. The power transmission device according to claim 1, comprising
a stator that includes a coil, wherein
the drive-side magnet has a cylindrical shape, and
the stator is disposed inside the drive-side magnet and rotates the drive-side magnet as a rotor.

37. The power transmission device according to claim 1, comprising:
a circuit board disposed at a position overlapping with the sealing member in an axial direction of the drive-side magnet in the driving side space; and
a circuit element disposed at a position overlapping with the sealing member in the circuit board in the axial direction of the drive-side magnet and generating radiation noise, wherein
the sealing member is made of a conductor.

38. The power transmission device according to claim 37, comprising:
an input shaft disposed in the driving side space and rotating integrally and coaxially with the drive-side magnet; and
a reinforcing plate disposed away from the sealing member through the circuit board in the driving side space, so as to reinforce a shaft receiving part of the input shaft, wherein
the reinforcing plate is made of a conductor, and
the circuit element is disposed at a position overlapping with the reinforcing plate in the axial direction of the drive-side magnet.

39. The power transmission device according to claim 38, wherein
the housing includes a body portion forming the driven side space and a case forming the driving side space,
the body portion is made of a conductor,
the sealing member is fixed to the body portion,
the sealing member includes a fixing portion with which the reinforcing plate is fixed, and
the fixing portion electrically connects the sealing member and the reinforcing plate.

40. The power transmission device according to claim 37, wherein
the circuit element is disposed so as to face a side of the sealing member with respect to the circuit board,
the housing includes a body portion forming the driven side space and a case forming the driving side space, and
the case is made of a conductor, and the case covers a gap between the sealing member and the circuit board from a radially outer side of the drive-side magnet.

41. The power transmission device according to claim 1, comprising:
an input shaft disposed in the driving side space and rotating integrally and coaxially with the drive-side magnet;
a reinforcing plate reinforcing a shaft receiving part of the input shaft in the driving side space;
a circuit board disposed so as to face the sealing member in the driving side space and fixed to the reinforcing plate; and
a circuit element bonded to the circuit board with a solder, wherein
the sealing member includes a fixing portion with which the reinforcing plate is fixed.

42. The power transmission device according to claim 41, wherein
the fixing portion is one of at least three fixing portions, and
the circuit element is disposed in a range inside an imaginary circumscribed circle circumscribing all of the fixing portions on the circuit board.

43. The power transmission device according to claim 41, wherein
the fixing portion is one of at least two fixing portions, and
the circuit element is disposed in a range between the fixing portions on the circuit board.

44. The power transmission device according to claim 35, wherein
the interposition member includes a cylindrical motor unit back yoke and a rotor cup, the motor unit back yoke is disposed between the rotor and the drive-side magnet, and the rotor cup covers the back yoke from one end side in an axial direction of the drive-side magnet,
the motor unit back yoke and the rotor cup are made of magnetic bodies, and
a position of end portions at one end side in the axial direction of the drive-side magnet, the pole piece, and the stationary magnet is positioned at a side away from the motor unit with respect to a position of end portions at one end side in the axial direction of the stator, the rotor, and the motor unit back yoke in an axial direction of the drive-side magnet.

45. The power transmission device according to claim 44, wherein
the rotor cup has a thickness in the axial direction of the drive-side magnet larger than a thickness of the motor unit back yoke in a radial direction of the drive-side magnet.

46. The power transmission device according to claim 35, wherein
the interposition member includes a cylindrical motor unit back yoke and a rotor cup, the motor unit back yoke is disposed between the rotor and the drive-side magnet, and the rotor cup covers the motor unit back yoke from one end side in an axial direction of the drive-side magnet, and
the rotor cup has a thickness in the axial direction of the drive-side magnet larger than a thickness of the motor unit back yoke in a radial direction of the drive-side magnet.
